(19) United States
(12) Patent Application Publication
(10) Pub. No.: US 2023/0324228 A1
(43) Pub. Date: Oct. 12, 2023

(54) SURFACE SENSITIZATION FOR HIGH-RESOLUTION THERMAL IMAGING

(71) Applicant: The Regents of the University of California, Oakland, CA (US)

(72) Inventors: Junqiao Wu, Oakland, CA (US); Kechao Tang, Oakland, CA (US); Kaichen Dong, Oakland, CA (US)

(21) Appl. No.: 18/304,244

(22) Filed: Apr. 20, 2023

Related U.S. Application Data
(63) Continuation of application No. PCT/US2021/056051, filed on Oct. 21, 2021.
(60) Provisional application No. 63/094,703, filed on Oct. 21, 2020.

(51) Int. Cl. G01J 5/04; G01J 5/0801; G01J 5/08; G01J 5/48; G01J 5/00

(52) U.S. Cl. CPC G01J 5/046; G01J 5/0801; G01J 5/0879; G01J 5/48; G01J 5/0025; G01J 5/0859

(57) ABSTRACT

A structured product, comprising: at least two layers comprising a first layer and a second layer; wherein: the first layer comprises at least one material having a temperature-dependent (e.g., a positive temperature-dependent or a negative temperature-dependent) wavelength-integrated emissivity (ε); the second layer comprises at least one reflective material that is reflective to light in an 8-14 μm wavelength range; and the structured product has a positive temperature-dependent wavelength-integrated emissivity. The structured product is useful in a method for thermal image sensitizing, the method comprising imaging, in an infrared spectrum, the structured product.

### CROSS-REFERENCE TO RELATED APPLICATIONS

This patent application is a continuation of International Patent Application No. PCT/US2021/056051, filed Oct. 21, 2021, which claims the benefit of U.S. Provisional Patent Application No. 63/094,703, filed Oct. 21, 2020, which are both incorporated by reference in their entireties for all purposes.

### STATEMENT REGARDING FEDERALLY SPONSORED RESEARCH OR DEVELOPMENT

This invention was made with Government support under Grant Number DMR-1608899 awarded by the National Science Foundation. The Government has certain rights in this invention.

### BACKGROUND

Thermography measures surface temperature profiles, which reveals rich information about surface and sub-surface thermal activities. Current thermography measurements rely on infrared (IR) cameras. The sensing mechanism of IR cameras is based on the fact that thermal power (normally within the wavelength range of 8-14 μm) radiated from an object is directly proportional to the fourth power of its temperature multiplied by its wavelength-integrated emissivity. As such, IR cameras sense IR radiation from the imaged object, and then calibrate the radiated power to obtain the object temperature by assuming the wavelength-integrated emissivity to be a constant.

Thermography plays a key role in diverse commercial and industrial applications, such as night vision, security surveillance, and electronics inspection to medical diagnostics, structural defect screening, and academic research. In all these applications, a higher temperature sensitivity is actively pursued in order to achieve better performance as well as to empower new applications, for example, early cancer diagnostics and single-cell thermography.

So far, all approaches to improve the temperature sensitivity are based on the development of better IR cameras, which target enhancing the detection sensitivity and conversion accuracy of IR radiated power. This approach leads to a saturated sensitivity at the end of the roadmap, with little improvement in the past decades. For example, for commercial IR cameras, their best temperature sensitivities are mostly over 20 mK. Ways to further refine, and hopefully leapfrog the temperature sensitivity of IR cameras are much desired.

### BRIEF SUMMARY

Disclosed is a structured product, comprising: at least two layers comprising a first layer and a second layer; wherein: the first layer comprises at least one material having a temperature-dependent (e.g., a positive temperature-dependent or negative temperature-dependent) wavelength-integrated emissivity (ε); the second layer comprises at least one reflective material that is reflective to light in an IR spectrum, for example, in an 8-14 μm wavelength range; and the structured product has a positive temperature dependent wavelength-integrated emissivity.

Also disclosed is a method for thermal image sensitizing, the method comprising imaging, in an infrared spectrum, the structured product.

Further disclosed is a method of making the structured product the method comprising attaching the first layer directly or indirectly to the second layer.

### BRIEF DESCRIPTION OF THE SEVERAL VIEWS OF THE DRAWING(S)

FIGS. 1A-1C are graphs depicting the physics and mechanism of a TIS-method. In contrast to conventional materials or black body, the sharp increase of thermal emissivity (ε) at the MIT of WₓV₁₋ₓO₂ introduces a high amplification (>15) of ΔT to ΔT_{IR} and thus reduction in NEDT. FIG. 1A: conventional materials and the black body have temperature-independent emissivity. In contrast, TIS-method uses a coating material (TIS-coating) whose emissivity has a sharp increase in a certain temperature range. FIG. 1B: IR power radiated from those materials or products versus actual temperature. FIG. 1C: When imaged by a conventional IR camera, the measured IR temperatures of those materials versus actual temperatures. The ΔT_{IR}/ΔT is also the enhancement factor for temperature sensitivities.

FIG. 2 is the side view of an example structure of TIS-coating, where a (optionally doped) VO₂/BaF₂/Ag tri-layer structure is on the surface of a flexible substrate.

FIG. 3 is the schematic illustration of enhanced temperature sensitivity and signal-to-noise ratio (SNR) using a TIS-coating, such as the TIS-coating of FIG. 2. As the object covered by the TIS-coating is heated beyond T_{c}, the VO₂, optionally doped (e.g., WₓV₁₋ₓO₂), transforms from a reflector (hence low absorbance and low emissivity) of the thermal IR spectrum in the I phase to a resonator (hence high absorbance and high emissivity) in the M phase. Hence, the IR power radiated from TIS-coating is abruptly increased.

FIG. 4 IR temperatures (directly from the IR camera) and temperature amplification versus actual temperatures. Three TIS-coatings with different W contents are measured (atomic fractions of W in the WₓV₁₋ₓO₂ layer).

FIG. 5A is the schematics and direct IR images of two closely placed tungsten heaters (˜1 mm separation). The tungsten heaters are buried under layers of black carbon tape on a paper board substrate. The IR images are captured without and with TIS-coating.

FIG. 5B is the calibrated actual temperature profiles along the dashed lines in FIG. 5A. The inset is a zoom-in view of the peak area. The twin-heater feature is distinctly resolved in the TIS-assisted imaging due to the ˜15 times improvement of the experimental thermal sensitivity.

FIG. 6A is the schematic and direct IR images of a high-emissivity coating (without TIS) placed next to a TIS-coating placed next to each other on a copper plate with a known temperature gradient. Note that these two IR images (i.e., “with TIS” and “without TIS”) have an identical actual temperature gradient.

FIG. 6B is a temperature profile on the surface by IR imaging without TIS, with TIS, and locally read by platinum resistance temperature detectors (Heraeus Sensor Technology). The inset is a zoom-in view of the part denoted by the box. The Pt thermocouples readouts served as verification of the temperature gradient in IR images. TIS enables much finer measurement of the temperature distribution, eliminating the artificial step feature caused by the experimental IR camera sensitivity limit (˜45 mK).

FIG. 7A is the schematics and optical image of injecting RMA cells into the belly of a mouse. RMA cells were injected at two adjacent spots to initiate the tumor growth in mice, which was then tracked by optical imaging, IR imaging without TIS, and with TIS.

FIG. 7B is the optical images and IR images (with and without TIS-coating) of the mouse belly, taken on different days after the injection of RMA cells at two near spots. TIS imaging reveals the two tumors in early stage after the injection when they are not yet detectable visibly or by conventional thermography. The inset white curves are temperature profiles extracted from the IR images, right across the centers of the two tumors, labeled with the amplitude of T_{IR} variation in each curve.

FIG. 7C is the optical images and IR images (with and without TIS-coating) of the mouse belly after the injection of RMA cells at three near spots. The three abnormal cold spots can only be distinguished in the IR image taken with TIS-coating. Imaging of three RMA tumors injected close to each other. Due to the limit of sensitivity, conventional IR imaging is unable to resolve those three tumors, while they can be distinguished clearly with the help of TIS.

FIG. 8 is the optical images and IR images of a forearm without and with TIS-coating. Imaging of cephalic veins on a human forearm without and with TIS. The IR image of the crossing point of veins is enhanced by over 10× in IR temperature contrast by the TIS coating.

FIG. 9 is the embodiment of thermal profile measurement of a switching chip imaged with and without TIS-coating. Left: optical pictures of the SPDT chip without and with TIS-coating. The red dashed box is the IR imaging area. Middle and Right: direct IR images without TIS-coating (top) and with TIS-coating (bottom). The input current is 7 mA and 10 mA, respectively. Also note that the IR images are normalized by the IR images captured with zero current input using the same setups. Imaging with TIS coating enables accurate observation and detailed evaluation of vague thermal profile on the chip caused by weak Joule heating that are otherwise undetectable.

FIG. 10A is the TIS-method enhanced thermography of a processor, allowing differentiation of various working modes. Left (Setup): optical images of the processor without and with TIS-coating. White dashed boxes are IR imaging areas. Right: direct IR images captured without and with TIS-coating at different working conditions.

FIG. 10B is the maximum IR temperature/actual temperature on the processor as a function of the data sensing frequency (or working frequency) in the processor.

FIG. 11A is the optical image and IR mapping of the temperature increase in a PCB board, where three currents flow through different circuit traces. Optical and IR mappings of temperature rise due to currents flowing in adjacent circuit traces on a PCB board, imaged without and with TIS.

FIG. 11B is the extracted current versus actual current in the traces. The dashed line and the gray shaded area respectively correspond to the ideal extracted current and +10% deviation. The experimental error bars for the data points are comparable to the size of the points. The squares are the experimental results where only one current flows through one circuit trace in the PCB. As for the demonstration of three currents flowing in the PCB, three experiments are conducted in total. The model used to extract currents are described in FIGS. 22A-22B and FIGS. 23A-23B.

FIG. 12A is the setup for the embodiment of structural defect inspection. A wood board is suspended above a hot plate. A V-shaped groove is created in the bottom surface of the wood board. IR images are taken from the top surface with and without TIS-coating. Top right: The optical image of the top surface of the wood board covered by TIS-coating. The hidden V-shape groove is denoted by red rectangles. Bottom right: the optical image of the bottom surface of the wood board. The blue box denotes the area that is covered by TIS-coating on the top surface.

FIG. 12B is the IR images with and without TIS-coating. The black dashed lines are the places where the two groove lines start to be distinguishable. The crosshairs in the left image indicates a temperature of 18.5° C., and the crosshairs in the right image indicates a temperature of 33.7° C. In the left image, the upper arrow indicates a temperature difference (ΔT) of ˜0.3° C., and the bottom arrow indicates a ΔT of ˜3° C.

FIG. 13 is a graph depicting a roadmap of NEDT for state-of-the-art commercial uncooled bolometers. Little advance was made in the past two decades, with the value currently saturated at 20-40 mK. The working bandwidth is 20-60 Hz.

FIG. 14 is a chart showing an NEDT comparison of the IR imaging system used herein to commercial IR cameras. TIS enables significant boosting of the NEDT of an ordinary-level IR camera to outperform all state-of-the-art IR detectors in the market.

FIG. 15 is a diagram of the TIS-assisted ambient thermography mechanism: the products and methods disclosed herein focuses on the amplification of thermal radiation power differentiated over object temperature (ΔP/ΔT), an approach distinct from all existing efforts, which have been instead striving to maximize ΔV/ΔP. The temperature sensitivity, i.e., noise-equivalent differential temperature (NEDT), of the system is given by the equation in the figure.

FIG. 16. Optimization of structural parameters in TIS by COMSOL simulation.

FIG. 16A: Integrated emissivity over the 8-14 μm atmospheric transparency window as a function of WₓV₁₋ₓO₂ and BaF₂ layer thicknesses. The emissivity of TIS at the M-state of WₓV₁₋ₓO₂ is optimized with WₓV₁₋ₓO₂ thickness at 30 nm, and BaF₂ thickness at 1550 nm. The integrated emissivity of TIS at I-state is low (<0.1) and basically independent of the WₓV₁₋ₓO₂ and BaF₂ thickness. FIGS. 16B-C: Dispersion of dielectric constant (ε=ε′+iε″) for WₓV₁₋ₓO₂ and Ag used in the simulation. The ε of BaF₂ is set as 2.5 independent of the frequency. In panel B, optical parameters of VO₂ were used to approximate the properties of WₓV₁₋ₓO₂ due to the lack of information of the latter in literature. On the emissivity shading scale, the darker shading for the circular shape represents an emissivity towards 1, whereas the lower left portion of the graph (at 1000, 10) represents an emissivity towards 0.4.

FIG. 17 depicts schematics and a picture for the fabrication of a TIS coating or structured product. 30 nm WₓV₁₋ₓO₂ thin films were grown on 170 μm thick borosilicate glass substrates using pulse laser deposition (PLD), followed by sequential deposition of 1.55 μm thick BaF₂ and 100 nm thick Ag layers via thermal evaporation. The tri-layer stacks were then transferred to flexible substrates (e.g., scotch tapes) by sticking the top Ag layer to the sticky side, and then etching off the borosilicate substrate by 49% HF.

FIG. 18A and FIG. 18B depict schematics for the setups to minimize impact of IR signals from surrounding environment to optimize sensitizing effects. FIG. 18A: Schematic and equations to demonstrate the impact of environmental radiation, which is denoted as Sen. The differentiation of radiation power (P_{rad}) with T has an additional negative term contributed by Sₑₙᵥ, suggesting that Sₑₙᵥ needs to be reduced to optimize the sensitizing effect.

FIG. 18B: Setups to minimize the impact from Sₑₙᵥ, either by doing the experiment in an outdoor environment with a clear sky, or using a “cold ceiling” setup. The “cold ceiling” is made by a ˜1 mm thick copper plate with high-emissivity coating facing the target object, and cooled by cryogen such as dry ice. These two setups were applied throughout the IR camera measurement in this work and were comparable in the effect of optimizing sensitizing performance.

FIG. 19A and FIG. 19B depict emissivity of TIS measured by Fourier-transform infrared spectroscopy (FTIR) and the IR camera. FIG. 19A: Spectral emissivity of a TIS measured by FTIR at different temperatures. An abrupt increase of emissivity is observed when the temperature increases above 35° C., which is the metal-insulator transition (MIT) temperature of the WₓV₁₋ₓO₂ (x=1.3%) in this TIS. FIG. 19B: The integrated emissivity over the 8-14 μm wavelengths (air transparency window) from the FTIR results, together with the results directly obtained by the IR camera. The higher emissivity extracted from the IR camera measurement is probably caused by signals contributed from environmental radiation, which is minimized but cannot be completely eliminated in the experiments (similar minimization effect between the outdoor and the cold ceiling setup).

FIGS. 20A-20C depict IR temperature (T_{IR}) as a function of real temperature (T) for two TIS samples imaged from different angles. FIG. 20A: IR images of the two TIS samples with x=1.5% and x=1.3% in the WₓV₁₋ₓO₂ layer, taken from different viewing angles. FIGS. 20A-20B: T_{IR} (viewed from different angles) plotted as a function of T for the TIS with x=1.5% and x=1.3%, showing angular independence of the T_{M}(T) curves.

FIGS. 21A-21C depict temperature calibration for a TIS with significant defects and non-uniformity. FIG. 21A: Actual temperature profile (obtained by conventional IR imaging) and an IR image assisted by a defective TIS of a surface with a rod-shaped thermal feature. We deliberately selected a TIS sample with many defects and significant performance non-uniformity, which initially generated an T_{IR} image that is severely deviated from the actual thermal feature. In the left panel, the outer portion of the oval shape (dark ring) is on the higher temperature end of the scale. In the right panel, the two lobes are on the higher temperature end of the temperature scale, whereas the square area is on the cooler end.

FIG. 21B: Collection of reference images for temperature calibration. The TIS was attached to a thermal stage with spatially uniform temperature, and T_{IR} images were sampled at N different real temperatures (T) of the thermal stage (which cover all working temperatures of TIS). Therefore we get a 3D matrix T_{IR}^{S}(X,Y,N) containing the necessary T_{IR}−T response information of the whole TIS. Note that only a part of the sampled T_{IR} images was presented in this panel for simplicity. In FIG. 21B, the white dot with crosshairs in the top row from left to right indicates temperatures of −12.3° C., −9.2° C., −5.5° C., and 0.7° C.; middle row: 6.0° C., 13.4° C., 17.9° C., and 22.7° C.; bottom row: 29.0° C., 34.3° C., 39.7° C., and 42.9° C. FIG. 21C. Calibration result. With interpolation based on T_{IR}^{S}(X,Y,N), pixel-by-pixel calibration of the defective raw IR image in FIG. 21A is executed. This calibration algorithm significantly improves the raw IR image and reproduces the actual rod-shape thermal pattern, without the loss of enhanced temperature resolution by TIS. Future large-scale applications of TIS would also benefit from this calibration procedure to eliminate spatial inhomogeneities. The oval shape is on the higher temperature end of the scale.

FIG. 22A and FIG. 22B depict schematics for simulation of the PCB copper circuit trace heating and detailed parameters used in the model. FIG. 22A: Cross-sectional view of the model with partial geometric parameters used in the simulation. The total thickness of the polymer layer (representing scotch tape, glue, soldermask, etc.) is calculated based on the individual thickness of each material. The copper traces are 35 μm thick and 0.5 mm wide, with a 0.5 mm gap between adjacent traces. FIG. 22B. Material properties used in the simulation. Most organic components (polypropylene, polyvinyl alcohol, epoxy, etc.) in the polymer layer have similar thermal properties. Therefore, for simplicity, the polymer layer material is set to be polypropylene (the main component of the scotch tape used). Other material properties are from references. The heating power in copper circuit traces is calculated using Joule-Lenz law with the copper conductivity of 6×10⁷ S/m. The temperature of the thermal stage beneath the whole structure is 33.6° C. To calculate the steady-state temperature profile of the TIS surface, the convective heat transfer coefficients of the air is set at 5 W/(m²·K). Based on the thermal profile of the single-trace experiments (FIGS. 23A-23B), the temperature of surrounding air is fitted to be 3.0° C. Note that the numerical thermal profiles in FIGS. 23A-23B and FIGS. 24A-24B are evaluated at the very top surface of TIS in the model.

FIG. 23A and FIG. 23B depict calibration of the model based on thermal profiles of different currents flowing through a single circuit trace. FIG. 23A: Optical and IR images of current flowing through a single trace in PCB (IR images were taken with TIS coating).

FIG. 23B: Comparison between simulated and experimental thermal profiles in Y-direction. Note that the experimental thermal profiles were obtained by averaging over the X-direction through the IR images shown in FIG. 23A. For FIG. 23A, The line forming in the middle of the images from left to right is on the higher temperature end of the temperature scale. In FIG. 23B, for the left and middle graphs, the amplitude of the current increases in the Y direction. For the right graph, the top line is simulation, and the bottom line is experiment (e.g., at current 1.1 A).

FIG. 24A and FIG. 24B depict extraction of the currents for 3-trace heating experiments. FIG. 24A: IR images for three different experiments without and with TIS. FIG. 24B: Representative current extraction in those three traces by fitting the simulated thermal profile to the experimental results. In FIG. 24A, the dark splotch on the 0.70 A dotted line for each image indicates a higher temperature on the temperature scale. In FIG. 24B, the top line in each graph is “experiment” and the bottom line in each graph is “simulation.”

FIG. 25. Results for the enhancement of IR imaging of tumors in mice. Imaging of a tumor induced by injecting B16-F10 cells, which is a melanoma cell line distinct from the type applied in FIG. 7B. TIS demonstrates similar advantages in detecting tumors earlier than conventional IR imaging.

FIG. 26. Working temperature range of TIS with different W fractions compared to target temperatures of different applications. The working temperature range of each TIS, defined by the MIT region featuring high dT_{IR}/dT, is typically around 2-3° C. Though seemingly narrow, this range of working temperature is sufficient for most applications demonstrated herein, which all have a well-defined, stable baseline surface temperature with very narrow temperature variations.

FIG. 27. Representative temperature resolution required for ambient thermography in various applications with paradigmatic feature sizes (see Table 1). TIS pushes boundaries of these applications as well as generates new markets.

FIG. 28A is an optical image of a fabricated TIS, showing high flexibility.

FIG. 28B is a false-colored cross section of the TIS film imaged by SEM before transfer.

### DETAILED DESCRIPTION

Disclosed is a structured product, comprising: at least two layers comprising a first layer and a second layer; wherein the first layer comprises at least one material having a temperature-dependent (e.g., a positive temperature-dependent or negative temperature-dependent) wavelength-integrated emissivity (ε); wherein the second layer comprises a reflective material that is reflective to light in an IR spectrum, for example, in an 8-14 μm wavelength range; and the structured product has a positive temperature dependent wavelength-integrated emissivity. In some aspects, although a particular layer (e.g., the first layer or the at least one material in the first layer) may provide a positive or negative temperature-dependent wavelength-integrated emissivity, the structured product as a whole provides a wavelength-integrated emissivity with a positive temperature dependence. In some aspects, however, the structured product has a negative temperature dependent wavelength-integrated emissivity.

The IR power radiated from an object is:

P_{rad}=εσT⁴ (1)

where ε is the wavelength-integrated emissivity for the object,

σ=2π⁵k_{B}⁴/15c²h³

is the Stefan-Boltzmann constant, T is the object temperature, k_{B} is the Boltzmann constant, h is Planck's constant, and c is the speed of light in vacuum.

IR cameras assume a constant wavelength-integrated emissivity ε₀ for all materials and thus:

P_{rad}=εσT⁴=ε₀σT_{IR}⁴ (2)

where T_{IR} is the temperature reading in IR cameras. For most conventional materials at ambient temperatures, E is nearly temperature-independent. Hence, the differentiation of T_{IR} over T:

dT_{IR}/dT=(ε/ε₀)^{1/4}(1+¼d ln ε/d ln T) (3)

is roughly equal to (ε/ε₀)^{1/4}, which is also nearly temperature-independent.

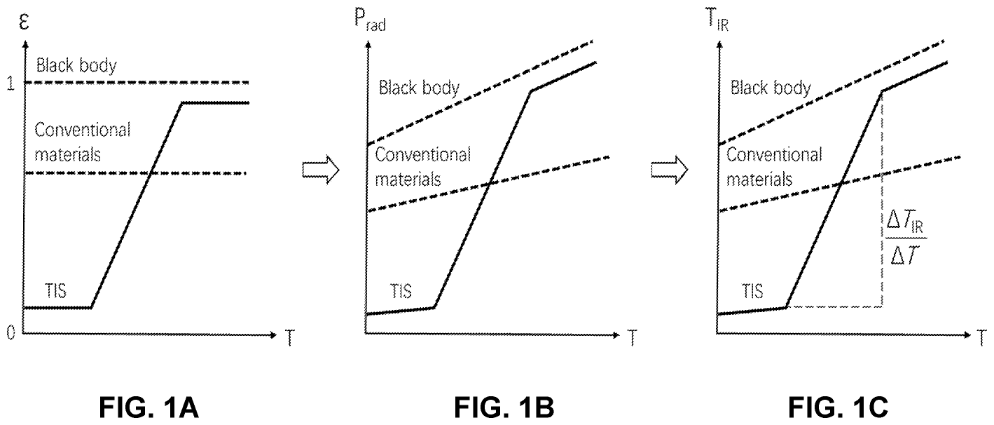

To further improve the temperature sensitivities of IR cameras, disclosed herein is a method of covering the target object with a material whose E has an unusual, strong, and positive T-dependence. Since E increases with temperature, according to Eq. (3), dT_{IR}/dT will be drastically amplified. In this way, for an IR camera with a temperature sensitivity Ho, when it is used together with our invention, the new temperature sensitivity will be improved to Ho/(dT_{IR}/dT). Furthermore, since dT_{IR}/dT can be pre-determined, the target object temperature (T) can be back-calculated based on the IR camera readouts and the amplifying factor of the coating material. Hence, using this method, the temperature sensitivities of all IR cameras can be greatly improved (by a factor over 10) without any modifications on the IR cameras themselves. The above process is illustrated in FIGS. 1A-1C. Herein such a method is termed “Thermal Imaging Sensitization” or “TIS.”

In contrast to conventional materials or black body, the sharp increase of thermal emissivity (ε) at the MIT of WₓV₁₋ₓO₂ introduces a high amplification (>15) of ΔT to ΔT_{IR} (see FIGS. 1A-1C) and thus reduction in NEDT. Generally NEDT has the relationship below:

NEDT=Vₙₒᵢₛₑ·dT_{IR}/dV·dT/dT_{IR}

The dT/dT_{IR} term generally corresponds to the term that is taken advantage of in the methods and materials disclosed herein and shown as the “TIS” line in FIGS. 1A-1C. The dT_{IR}/dV term generally corresponds to conventional materials and existing unsatisfactory efforts (see also the “conventional materials” line in FIGS. 1A-1C).

As used herein, the term “TIS-method” is a method that assists thermal imaging sensitizing using a coating material whose E, in some aspects, has a positive T-dependence, while the term “TIS-coating” denotes a coating, coating material(s), or a structured product comprising a material that can be employed in the “TIS-method.” In practical applications, a TIS-coating can be a single-component material, mixed polymers, or nano- or micro-fabricated photonic nanostructures, or any other structure or combination as further described elsewhere herein. One aspect of the TIS-coating is a strong and positive T-dependent E.

In some aspects, the term “TIS-coating” refers to a phase change material (e.g., vanadium dioxide), and in some aspects TIS-coating refers to a structured product comprising the phase change material, as will typically be clear from context.

As used herein, the term “positive temperature-dependent wavelength-integrated emissivity” means that the wavelength-integrated emissivity increases as the temperature increases, particularly over a given temperature range. This temperature range is typically a temperature range of interest for using the TIS-coating (structured product), for example, a temperature range of 20° C. to 70° C. The emissivity need not increase over this entire temperature range, but merely needs to increase at some point within the temperature range of interest, for example, near human skin temperature of about 37-39° C.

As used herein, the term “wavelength-integrated emissivity” means the emissivity integrated over a wavelength range of interest. Generally, this wavelength range of interest is in the thermal IR spectrum. Typically herein the emissivity is integrated over the range 8-14 m, but can be integrated over a different range if appropriate for the given materials and application employed, such as 1-30 μm, 5-25 μm, 5-20 μm, or 8-15 μm.

Although in some instances the article “the” precedes the term “TIS-coating,” “TIS-method,” “structured product,” or other terms herein, such article is used for grammatical convenience and is not intended to imply that there is only one method or one coating, etc. Rather, there are multiple aspects and high variability to the structure of the inventive products, methods of making, and methods of use thereof, as is particularly clear from the disclosure as a whole.

As used herein, the terms “about” and “approximately,” when used to modify an amount specified in a numeric value or range, mean that slight variations from a stated value may be used to achieve substantially the same results as the stated value. In circumstances where this definition cannot be applied or is exceedingly difficult to apply, then the terms “about” and “approximately” mean a reasonable deviation from the value known to a skilled person in the art, such as, if “X” were the value, for example, “about X” or “approximately X” would indicate a value from 0.9X to 1.1X, e.g., a value from 0.95X to 1.05X, or a value from 0.98X to 1.02X, or a value from 0.99X to 1.01X. Any reference to “about X” or “approximately X,” where X is a value disclosed herein, specifically indicates at least the values X, 0.9X, 0.91X, 0.92X, 0.93X, 0.94X, 0.95X, 0.96X, 0.97X, 0.98X, 0.99X, 1.01X, 1.02X, 1.03X, 1.04X, 1.05X, 1.06X, 1.07X, 1.08X, 1.09X, and 1.1X, and values within this range.

Any number disclosed herein can be preceded by the word “about,” “at least,” “at least about,” “less than,” or “less than about,” and any two numbers herein can be used singly to describe a single point or an open-ended range, or can be used in combination to describe multiple single points or a close-ended range.

Aspects include an example of TIS-coating, and its applications in improving IR cameras for early cancer screening, electronics analysis, and structure defect detection, as well as other applications where the TIS-coating is useful, such as the other applications disclosed herein.

Disclosed is a structured product, comprising:
at least two layers comprising a first layer and a second layer;
wherein:
the first layer comprises at least one material having a temperature-dependent wavelength-integrated emissivity (ε);
the second layer comprises at least one reflective material that is reflective to light in an IR spectrum, for example, in an 8-14 μm wavelength range; and
the structured product has a positive temperature dependent wavelength-integrated emissivity.

In some aspects, the at least one material has a positive temperature-dependent wavelength-integrated emissivity. In some aspects, the at least one material has a negative temperature-dependent wavelength-integrated emissivity. In some aspects, the structured product has a positive temperature dependent wavelength-integrated emissivity. In some aspects, the structured product has a negative temperature dependent wavelength-integrated emissivity.

In some aspects, the first layer and the second layer need not be in direct contact. In some aspects, the first layer and the second layer are in direct contact. In some aspects, the each of the first layer and the second layer independently are homogenous with any components contained therein evenly dispersed. In some aspects, the first layer is heterogeneous, which first layer comprises nanostructures of the at least one material dispersed in or on a dielectric material (e.g., a polymer matrix, metal halide, metal selenide, or any other dielectric material disclosed herein).

In some aspects, the structured product comprises at least three layers, at least four layers, at least five layers, or at least six layers.

In some aspects, the at least one material comprises or consists of vanadium dioxide, germanium-antimony-tellurium, or a combination thereof. In some aspects, the functional material that is used to compose a TIS-coating may be other materials, such as materials having a dielectric constant having a vast change as its temperature increases, especially those thermally triggered phase change materials, for example, germanium-antimony-tellurium. In some aspects, when germanium-antimony-tellurium is employed, the phase transition occurs at much higher temperatures than when the at least one material comprises mainly or only vanadium dioxide (e.g., tungsten doped or undoped vanadium dioxide), and generally pulsed heating (nanosecond to microsecond) is employed to achieve such high temperatures.

In some aspects, the at least one material comprises vanadium dioxide (VO₂). Vanadium dioxide is a material that can serve as a component in the material for TIS coating. Generally, VO₂ undergoes a temperature-driven, reversible phase change from an insulating (I) phase to a metallic (M) phase as it is heated above its transition temperature (T_{c}=67° C.). Moreover, the T_{c} of VO₂ can be conveniently tuned to lower temperatures by doping with tungsten or other metals or elements. Note that an arbitrary T_{c} within the temperature range of interest (i.e., near room temperature) can be accurately achieved by controlling the doping level of tungsten or other metal or element. The I and M phases of VO₂ have drastically different dielectric constants: in the 8-14 μm wavelength range, the I-phase VO₂ is almost transparent, while the M-phase VO₂ behaves as an absorptive and reflective metal. That property enables a high modulation depth of these VO₂-based IR devices, and thus VO₂ is an ideal functional material for a TIS-coating disclosed herein.

In some aspects, the at least one material is doped with tungsten, chromium, gallium, aluminum, or any combination thereof. In some aspects, the at least one material comprises tungsten-doped vanadium dioxide.

In some aspects, the working temperature of TIS coating can be pre-designed by tuning the T_{c} of the VO₂ layer via doping or strain engineering. For example, the T_{c} of W-doped VO₂ (WₓV₁₋ₓO₂) can be effectively tuned from 67° C. to −100° C. by varying the W composition.

T_{c}≈67° C.−24° C.·x·100 (4)

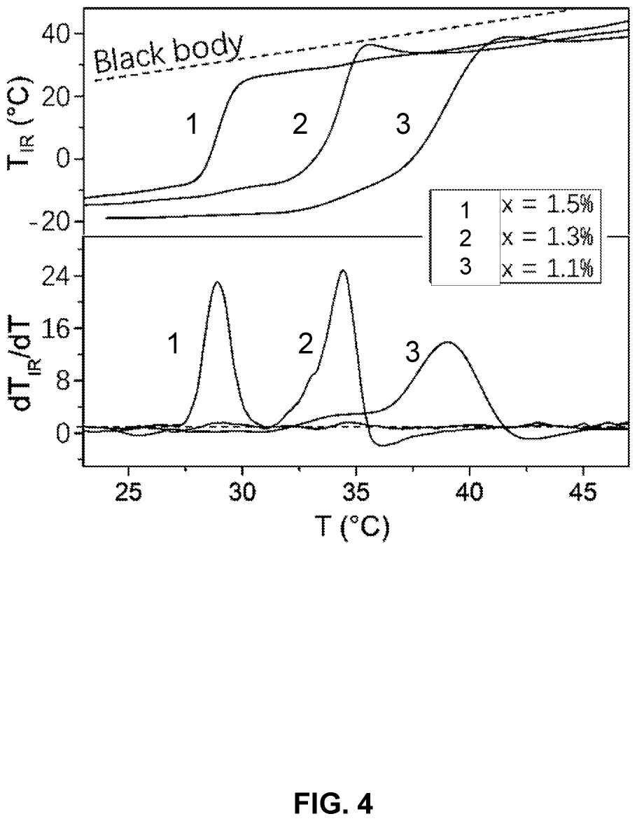

Experimental performance of TIS-coating made of WₓV₁₋ₓO₂ at different W doping levels (x=1.1%, 1.3% and 1.5%) is presented in FIG. 4.

In some aspects, the at least one material comprises tungsten-doped vanadium dioxide having a formula of WₓV₁₋ₓO₂, wherein x is 0-5%, 0.1-2%, 0.5-2%, 0.5-1.8%, 0.8-1.5%, 1-1.5%, 1.1-1.5%, 1.1-1.3%, or 1.3-1.5%.

In some aspects, alternatively or additionally, the at least one material can be doped with other components, such as gallium, aluminum, or a combination thereof, to adjust the T_{c} to higher temperatures above 67° C.

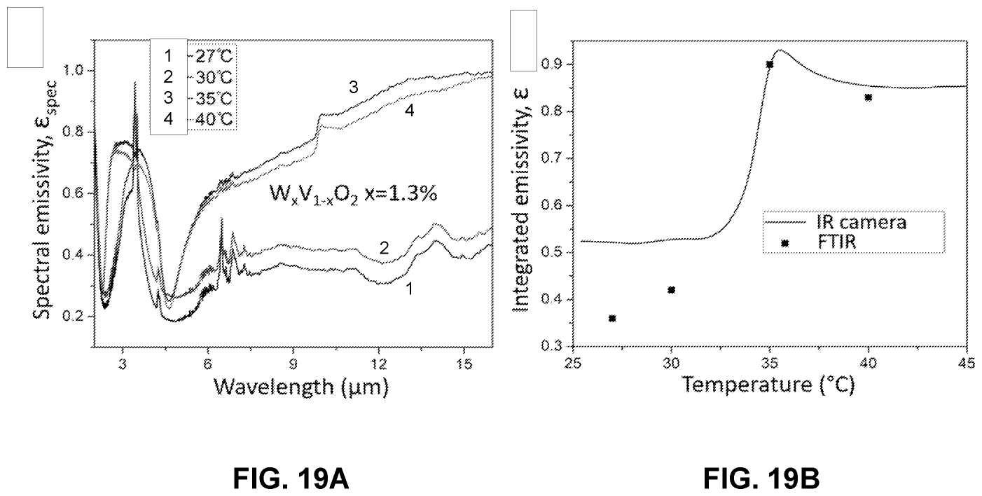

In some aspects, within a temperature range of −100 to 100° C., the at least one material has a wavelength-integrated emissivity temperature-dependence of at least 0.01 per ° C., at least 0.05 per ° C., at least 0.1 per ° C., at least 0.2 per ° C., at least 0.25 per ° C., 0.01-0.25 per ° C., 0.01-0.3 per ° C., 0.05-0.2 per ° C., 0.1-0.25 per ° C., 0.2-0.25, or 0.1-0.3 per ° C., as measured by IR camera or FTIR, wherein the wavelength-integrated emissivity is integrated over a wavelength range of 8-14 μm. The wavelength-integrated emissivity temperature-dependence generally is determined by plotting the wavelength-integrated emissivity (as measured by IR camera or FTIR) versus temperature over a temperature range of interest and finding the maximum slope within the temperature range. The wavelength-integrated emissivity need not change (i.e., depend on temperature) over the entire temperature range, but need only change at some point within the indicated temperature range. See, e.g., FIG. 19B, showing a slope of about 0.25 per ° C. for an IR camera measurement, and 0.094 per ° C. for FTIR. The change generally indicates the phase change between M and I phases. As a comparison, this parameter is lower than 0.001 per ° C. for silicon or graphite.

In some aspects, the wavelength-integrated emissivity is between 0.3 to 1, wherein the wavelength-integrated emissivity is integrated over a wavelength range of 8-14 μm. When the at least one material is in an I phase, the wavelength-integrated emissivity is generally between about 0.4-0.7, or 0.5-0.6, or 0.5-0.55, when integrated over a wavelength range of 8-14 μm. When the at least one material is in an M phase the wavelength-integrated emissivity is generally between 0.7-1, 0.75-0.95, or 0.8-0.9, when integrated over a wavelength range of 8-14 μm.

In some aspects, the at least one material exhibits a thermally-triggered phase transition from an insulating phase to a metallic phase when temperature is increased, and optionally wherein the phase transition is reversible. In some aspects, the phase transition is reversible. In some aspects, the phase transition is irreversible.

In some aspects, in a temperature range of 20-60° C., the thermally-triggered phase transition results in an increase in the wavelength-integrated emissivity of at least 0.1, at least 0.2, 0.25, at least 0.3, at least 0.32, at least 0.35, 0.1-0.4, 0.1-0.3, 0.1-0.35, 0.2-0.35, or 0.25-0.35, wherein the wavelength-integrated emissivity is integrated over a wavelength range of 8-14 μm.

In some aspects, the thermally-triggered phase transition occurs in a temperature range of −100° C. to 100° C., 10° C. to 80° C., 20° C. to 70° C., or 20° C. to 50° C. As described elsewhere herein, when the at least one material comprises or consists of vanadium dioxide, the thermally-triggered phase transition occurs at around 67° C., though this temperature can be lowered by doping with tungsten (or other materials, elements, or metals), or can be raised by doping with gallium or aluminum (or other materials, elements, or metals), or can be tuned by any combination thereof (e.g., tungsten, gallium, aluminum, other materials, other elements, other metals, or any combination thereof). The thermally-triggered phase transition need not occur over the entire temperature range, but merely needs to occur at some point within the indicated window.

In some aspects, in a 8-14 μm wavelength region, the metallic phase absorbs more light than the insulating phase.

In some aspects, the at least one reflective material comprises or consists of a metallic material, a ceramic, an artificial photonic structure, or a combination thereof.

In some aspects, the metallic material comprises gold, silver, aluminum, tungsten, platinum, chromium, titanium, copper, ruthenium, alloys thereof, or any combination thereof.

In some aspects, the ceramic comprises indium tin oxide, M-phase vanadium dioxide, TiN, SrRuO₃, or any combination thereof.

In some aspects, the artificial photonic structure comprises a metamaterial, a photonic crystal, a stacking layer, or any combination thereof.

In some aspects, the structured product further comprises at least one dielectric material. In some aspects, the at least one dielectric material is a dielectric spacing material, such as a dielectric or polymeric material, or a combination thereof, that is transparent in the 8-14 μm spectral range. In some aspects, the at least one dielectric material has a transmittance of at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or about 100% to light in a wavelength range of 8-14 μm.

In some aspects, the at least one dielectric material comprises at least one metal halide, at least one metal selenide, at least one semiconductor material, at least one polymer, or any combination thereof.

In some aspects, the at least one metal halide comprises barium fluoride, magnesium fluoride, calcium fluoride, beryllium fluoride, strontium fluoride, potassium fluoride, potassium bromide, potassium chloride, potassium iodide, sodium chloride, sodium fluoride, sodium bromide, sodium iodide, cesium iodide, or any combination thereof.

In some aspects, the at least one metal selenide comprises zinc selenide, gallium(II) selenide, indium(III) selenide, sodium selenide, cadmium selenide, lead selenide, copper selenide, or any combination thereof.

In some aspects, the at least one semiconductor material comprises zinc sulfide, germanium, silicon, thallium bromoiodide KRS-5, gallium arsenide, cadmium telluride, germanium-antimony-tellurium, amorphous germanium-antimony-tellurium, or any combination thereof.

In some aspects, the at least one polymer comprises polyethylene, silicone, polycarbonate, poly(methyl)(meth)acrylate, polyethylene terephthalate, polyvinyl chloride, polypropylene, styrene-acrylonitrile copolymer, polystyrene, polytetrafluoroethylene, poly(vinylidene fluoride-cohexafluoropropene) (P(VdF-HFP)IP), hierarchically porous poly(vinylidene fluoride-cohexafluoropropene) (P(VdF-HFP)IP), any copolymer thereof, or any combination thereof. In some aspects, the at least one polymer is a polymer matrix. As used herein, the term “poly(methyl)(meth)acrylate” refers to optional “methyl” and optional “meth” in the polymer structure, such that the term encompasses polyacrylate, polymethylacrylate, polymethacrylate, and polymethylmethacrylate, and any combination thereof.

In some aspects, the first layer further comprises the at least one dielectric material. In some aspects, the at least one material is dispersed in or on the at least one dielectric material (e.g., polymer matrix or other dielectric material disclosed herein). In some aspects, the dispersed material is in the form of a cube array structure, a cube array metamaterial structure, a hole array structure, a particle structure, a nanoparticle structure, a microparticle structure, a nanostructure, a fabricated nanostructure, a photonic structure, a fabricated photonic nanostructure, or any combination thereof. In some aspects, the dispersed material is dispersed in a polymer matrix (e.g., nanoparticles dispersed in a polymer matrix). In some aspects, the spacing between dispersed or fabricated material (e.g., in the form of nanostructures, such as parallel lines or cubes) is such that a resonance is created when imaged with an IR camera or other device imaging in the IR range, such as 8-14 μm, when the at least one material is in a metallic phase or other more light-absorbing phase. This spacing between nanostructures or microstructures can be described with the variable d that is disclosed elsewhere herein with respect to the thickness of the third layer.

In some aspects, the structured product further comprises a third layer disposed between the first and second layers, wherein the third layer comprises the at least one dielectric material.

In some aspects, when the at least one material is in a metallic phase (or a phase that is more light-absorbing to IR light than a different phase of the at least one material), at least one of the following is satisfied:
(a) components of the dispersed material are spaced from each other such that a quarter wavelength photonic resonance cavity is formed with light having a wavelength of 8-14 μm;
(b) the dispersed material in or on the first layer is spaced from the at least one reflective material such that a quarter wavelength photonic resonance cavity is formed with light having a wavelength of 8-14 μm;
(c) the first layer comprises a continuous film of the at least one material, and the continuous film is spaced from the at least one reflective material such that a quarter wavelength photonic resonance cavity is formed with light having a wavelength of 8-14 μm; or
(d) any combination thereof.

In some aspects, when the at least one material is in a metallic phase: (a) is satisfied; (b) is satisfied; (c) is satisfied; (a) and (b) are satisfied; (b) and (c) are satisfied; (a) and (c) are satisfied; or (d) is satisfied.

In some aspects, the structured product comprises a trilayer structure. In some aspects, the structured product comprises a trilayer structure, wherein the first layer comprises the at least one material, the second layer comprises the at least one reflective material (e.g., reflective to IR light in the 8-14 μm range), and the third layer comprises the at least one dielectric material. In some aspects, the structured product comprises a trilayer structure, wherein the first layer comprises WₓV₁₋ₓO₂, the second layer comprises the at least one reflective material, and the third layer comprises the at least one dielectric material, wherein x is 0-5% or 1-1.5% (or any other amount disclosed herein), and wherein the third layer is disposed between the first layer and the second layer. In some aspects, the structured product comprises a trilayer structure, wherein the first layer comprises WₓV₁₋ₓO₂, the second layer comprises barium fluoride, and the third layer comprises aluminum, wherein x is 0-5% or 1-1.5% (or any other amount disclosed herein), and wherein the second layer is disposed between the first layer and the third layer.

In some aspects, when at least two layers are employed (e.g., two layers, or three layers), the first layer has any suitable thickness. In some aspects, the first layer has a thickness of 1-500 nm, 20-200 nm, 30-150 nm, 50-125 nm, 75-110 nm, 20-50 nm, or 25-40 nm. In some aspects, the first layer comprises a continuous film of the at least one material, optionally in combination with any other suitable material, such as the at least one dielectric material (e.g., a polymer matrix).

In some aspects, when at least two layers are employed (e.g., two layers, or three layers), the second layer has any suitable thickness. In some aspects, the second layer has a thickness of 10-500 nm, at least 10 nm, at least 50 nm, at least 100 nm, 25-400 nm, 50-300 nm, or 75-200 nm. In some aspects, the second layer comprises a continuous film of the at least one reflective material.

In some aspects, when at least three layers are employed (e.g., three layers), the third layer has a thickness of 0.01-10 μm, 1-2.5 μm, 0.5-5 μm, 0.8-4 μm, 1-3 μm, or 1.2-2 μm. In some aspects, the third layer has a thickness that satisfies the following equation:

d=(0.25×m×λ)/n

wherein d is thickness of the third layer, m is any integer greater than or equal to one, n is the real part of the refractive index of the third layer, and λ is a resonance peak wavelength in a range of 8-14 μm (e.g., about 9 μm). In some aspects, m is 1, 2, 3, 4, 5, 6, or 7, though typically m is chosen to be 1. In some aspects, thickness d is chosen such that a quarter wavelength photonic resonance cavity is formed with light having a wavelength of 8-14 μm, the thickness d being the thickness of the at least one dielectric material that provides spacing between the first layer and the second layer (i.e., whether a quarter wavelength photonic cavity is formed depends on the distance between the first layer and the second layer). The variable d can also be used to describe the spacing between nanostructures or microstructures of the at least one material when dispersed or fabricated in or on the first layer. In some aspects, the thickness d (e.g., of the third layer or the spacing between nano/microstructures) can be selected to be within 20%, within 10%, within 5%, within 4%, within 3%, within 2%, or within 1% of (0.25×m×λ)/n.

In some aspects, the structured product further comprises a flexible substrate disposed on the first layer, the second layer, or both. Generally, any suitable flexible substrate can be used. In some aspects, the flexible substrate facilitates adhering the structured product to a surface to enhance the contrast between small temperature variations in the surface when imaging in the IR spectrum (e.g., comprising 8-14 μm). In some aspects, the flexible substrate is configured to conduct thermal energy to the at least one material. In some aspects, the flexible substrate further comprises an adhesive or glue disposed on a surface of the flexible substrate. In some aspects, such adhesive or glue is thermally conductive. Generally, the thickness of the flexible substrate, which may optionally comprise an adhesive or glue, is not critical provided that the flexible substrate along with optional adhesive/glue is thin enough or thermally conductive enough to transmit heat from an underlying surface of interest to the at least one material so as to cause a phase change of the at least one material.

In some aspects, the flexible substrate can have the structured product disposed thereon, such that the flexible substrate is positioned between the surface of interest and the phase change material. In this aspect, the structure comprises: (surface)/(flexible substrate)/(first layer)/(second layer). When a third layer (e.g., at least one dielectric material) is employed, the third layer is disposed between the first layer and second layer: (surface)/(flexible substrate)/(first layer)/(third layer)/(second layer). When a third layer is not employed, a dielectric material can be part of the first layer (e.g., in which at least one material is dispersed in or on a polymer matrix). In this aspect, the flexible substrate need not be transparent but rather should merely have sufficient thickness or thermal conductance to transmit thermal energy from the underlying surface of interest to the phase change material to cause a phase change such that minute temperature variations in the surface of interest can be imaged in the IR spectrum.

In some aspects, the flexible substrate is not positioned between the surface of interest and the phase change material, but rather the flexible substrate is used more like a wrapping or bandage to adhere the structured product to a surface of interest. In this aspect, the structure comprises: (surface)/(first layer)/(second layer)/(flexible substrate). When a third layer (e.g., at least one dielectric material) is employed, the third layer is disposed between the first layer and second layer: (surface)/(first layer)/(third layer)/(second layer)/(flexible substrate). When a third layer is not employed, a dielectric material can be part of the first layer (e.g., in which at least one material is dispersed in or on a polymer matrix). In this aspect, the flexible substrate need not be thermally conductive (e.g., thin), though it may be, but rather should have sufficient transparency or transmittance in the IR spectrum to transmit IR light (e.g., in the 8-14 μm range) during imaging in the IR spectrum. In this aspect, the flexible substrate can comprise any of the dielectric materials disclosed herein, which generally also have this IR light transmittance feature. In other aspects, even when the flexible substrate has the structure described in this paragraph, the flexible substrate need not have the indicated transparency if a hole or window is provided in the flexible substrate to allow IR light to have direct access to the structured product (e.g., the first layer).

In some aspects, the flexible substrate comprises a polymer tape, polyethylene tape, SCOTCH tape, KAPTON tape, woven fabric, nonwoven fabric, or any combination thereof. In some aspects, the flexible substrate comprises layers of any of these materials, such as layers of polyethylene.

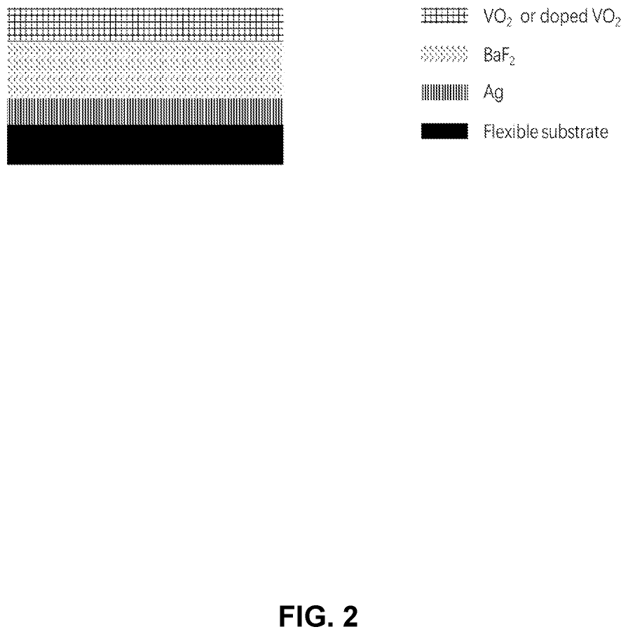

FIG. 2 shows an example of a TIS-coating, which in this aspect is a nanophotonic structure composed of a 30 nm-thick VO₂ film, a 1.5 μm-thick barium fluoride (BaF₂) film, and a 100 nm-thick silver (Ag) film. All the above films are sitting on the top of a flexible substrate such as an adhesive tape (e.g., SCOTCH tape). To fabricate such a structure, in some aspects the VO₂ film is firstly deposited onto borosilicate glass substrate via pulsed laser deposition or sputtering, which is followed by the deposition of BaF₂ and Ag films by thermal evaporation. However, any of these depositions can be performed by any suitable coating method known in the art. In an aspect, the tri-layer structure is then transferred to the flexible substrate while the borosilicate glass is removed by etching or other suitable method.

According to the Kirchhoff's law of radiation, the emissivity E and absorptivity (a) of TIS-coating are identical, so the tunability of E in the TIS-coating can be explained by the tunability of a as follows: At higher temperatures, the top VO₂ film is M-phase, so a ¼-wavelength photonic cavity is formed in the VO₂/BaF₂/Ag sandwich structure. In an aspect, the thicknesses of VO₂ and BaF₂ are selected so that strong absorption at 8-14 μm is achieved. At lower temperatures, both I-phase VO₂ and BaF₂ are transparent in the IR range, so all incoming IR light penetrates through them and is reflected by the underlying Ag layer, resulting in a negligible a for the TIS-coating. In summary, in this aspect, upon heating over T_{c}, the TIS-coating exhibits an abrupt increase of its E because of the thermally triggered VO₂ phase transition.

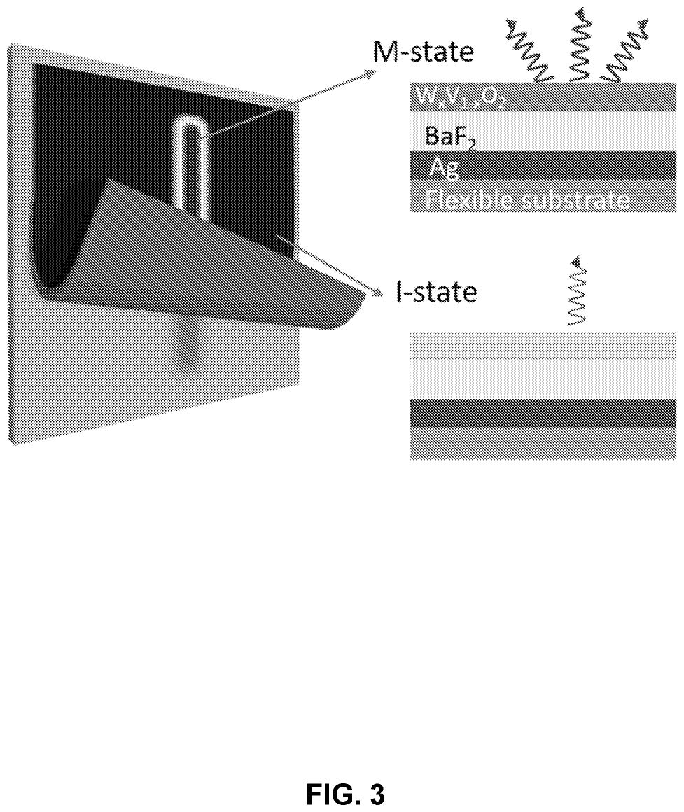

In an aspect, an application scenario of TIS-coating is illustrated in FIG. 3, where a TIS-coating, with its T_{c} carefully designed, is pasted onto a target object that has a thermal profile with weak or minute temperature variation. The adhesion between the TIS-coating and the target object can be enhanced by using a thin adhesive layer or glue, which are generally thermal conductive at the scale employed so as to transmit heat to the phase change material (e.g., VO₂). The small temperature variation across T_{c} causes a large local change in E of the TIS-coating, which causes a vast difference in the locally radiated IR power. This large IR power difference will be easily resolved by IR cameras, including standard off-the-shelf IR cameras, and thus increase their temperature resolution as well as signal-to-noise ratios (SNRs) without necessarily modifying the hardware or software of the IR camera in any way.

In some aspects, disclosed is a method of making the structured products (TIS-coatings) disclosed herein. Elements or features in this method of making that use the same or similar terminology to any element or feature in the structured product (TIS-coating) can have any features or characteristics disclosed elsewhere herein for the same elements/features in the structured product. In some aspects, the method comprises attaching the first layer directly or indirectly to the second layer. As used herein, “attaching the first layer directly to the second layer” means that the first layer is brought into physical direct contact with the second layer, either in one step or as part of a multi-step method. As used herein, “attaching the first layer indirectly to the second layer” means that the first layer and second layer are indirectly attached to one another, e.g., by way of one or more intervening layers, such as the third layer.

In some aspects of the method of making, the method further comprises adhering the first layer or the second layer to a flexible substrate.

In some aspects of the method of making, the structured product comprises a trilayer structure comprising the first layer, the second layer, and the third layer; the attaching step comprises indirectly attaching the first layer to the second layer, and the attaching step further comprises:
depositing the first layer on a sacrificial substrate,
forming the third layer on the first layer,
positioning the second layer on the third layer, thereby resulting in the trilayer structure,
optionally, transferring the trilayer structure to a flexible substrate, and
removing the sacrificial substrate.

In some aspects of the method of making, at least one of the following is satisfied:
(a) the at least one material comprises WₓV₁₋ₓO₂ wherein x is 0-5%, optionally wherein x is 1-1.5%;
(b) the at least one dielectric material comprises a metal halide optionally comprising barium fluoride;
(c) the at least one reflective material comprises silver;
(d) the sacrificial substrate comprises borosilicate glass;
(e) the depositing step comprises pulsed laser deposition, sputtering, wet chemistry, thermal evaporation, or any combination thereof,
(f) the forming step comprises pulsed laser deposition, sputtering, wet chemistry, thermal evaporation, or any combination thereof,
(g) the positioning step comprises pulsed laser deposition, sputtering, wet chemistry, thermal evaporation, or any combination thereof,
(h) the removing step comprises etching;
(i) a combination thereof; or
(j) any combination thereof.

In some aspects of the method of making, the following combinations are satisfied: (a) and (b); (a), (b), and (c); (a), (b), (c), and (d); (a), (b), (c), (d), and (e); (a), (b), (c), (d), (e), and (f); (a), (b), (c), (d), (e), (f), and (g); (a), (b), (c), (d), (e), (f), (g), and (h).

In some aspects, the sacrificial substrate comprises glass, borosilicate glass, soda-lime glass, lead glass, aluminosilicate glass, fumed silica glass, metal, gold, platinum, or any combination thereof.

In some aspects of the method of making, the depositing step, the forming step, or the positioning step independently comprise(s) pulsed laser deposition, sputtering, wet chemistry, thermal evaporation, or any combination thereof. In some aspects, for commercial scale production, the methods comprise sputtering or wet chemistry, or both.

In some aspects, the etching comprises etching with hydrofluoric acid or aqua regia.

Several applications of a TIS-coating and/or a TIS-method are possible. Such aspects may be combined in any way to produce another aspect.

In some aspects, disclosed is a method for thermal image sensitizing (“TIS-method”), the method comprising: imaging, in an infrared spectrum, the structured product.

Elements or features in this imaging method that use the same or similar terminology to any element or feature in the structured product (TIS-coating) can have any features or characteristics disclosed elsewhere herein for the same elements/features in the structured product.

In some aspects, the imaging is performed in a temperature range of −100° C. to 100° C., 10° C. to 80° C., 20° C. to 70° C., or 20° C. to 50° C.

In some aspects, the imaging is performed in a wavelength range of 5-20 μm or 8-14 μm.

In some aspects, the method increases temperature sensitivity by at least 2 times, at least 5 times, at least 10 times, at least 15 times, 2-20 times, 2-15 times, 2-10 times, 3-15 times, 3-10 times, 5-20 times, 5-15 times, 10-15 times, or 10-20 times, compared to a temperature sensitivity of an otherwise identical method that does not employ the structured product.

In some aspects, the method resolves temperature differences of less than 45 mK, less than 40 mK, 1-40 mK, 1-30 mK, 1-10 mK, 1-5 mK, 3-15 mK, at least 3 mK, at least 4 mK, at least 5 mK, 3-5 mK, or 2-5 mK.

In some aspects, the imaging step employs an infrared imaging device that indicates a temperature reading by assuming a constant wavelength-integrated emissivity, and the method further comprises: calculating an actual temperature using the following equation:

$$\frac{{dT}_{IR}}{dT} = {( \frac{ε}{{ε}_{0}} )}^{1 / 4} ( 1 + \frac{1}{4} \frac{dln ε}{dlnT} )$$

wherein T_{IR} is the temperature reading, T is the actual temperature, ε₀ is the constant wavelength-integrated emissivity, and ε is an actual emissivity, and
optionally wherein the calculating step assumes dT_{IR}/dT is equal to (ε/ε₀)^{1/4}.

In some aspects, this equation can be simplified by assuming in the calculating step that dT_{IR}/dT is equal to (ε/ε₀)^{1/4}. In other aspects, the full equation is used in the calculating step (i.e., without the simplifying assumption).

In some aspects, the method of imaging the structured product in an infrared spectrum is used in applications such as buildings, vehicles, and machineries; bio-medical; electronics; and microbiology.

In some aspects, the structured product is disposed on a surface, and the method detects temperature differences on the surface for sensing ultra-weak temperature variations (e.g., higher or lower temperatures), detecting spatially small thermal features, enhancing signal-to-noise compared to otherwise identical imaging without the structured product, or any combination thereof. In some aspects, the surface comprises animal tissue, a device, integrated circuit, electronic chip, processor, CPU, a building material, machinery part, other material, vehicle, machinery, buildings, bridges, structures, exposed cracks, walls (e.g., for high-level moisture), or any combination thereof.

In some aspects, the structured product is disposed on animal tissue, wherein the method detects temperature differences on the animal tissue for medical diagnostics, medical thermography, early stage cancer diagnostics, diagnosis of cancer, determining tumor size and distribution information, vasculature imaging, determining crossing points of veins or arteries, facilitating intravenous injections of drug solutions, monitoring health parameters, monitoring blood pressure, diagnostics of circulatory disorders, diagnostics of musculoskeletal disorders, diagnostics of rheumatic diseases, dermatological applications, evaluation of transplantation, imaging of brain activities, observing temperature variations in a cell (e.g., single-cell thermography), or any combination thereof.

In some aspects, the structured product is disposed on a device, integrated circuit, electronic chip, or processor, wherein the method detects temperature differences on the device, integrated circuit, electronic chip, or processor for mapping fine temperature distributions, designing thermal budgets, inspecting failures, inspecting or sensing circuit defects, locating a heating source, resolving small temperature variations, non-invasive inspecting of working conditions, inspecting working loads, inspecting frequencies of electrical or mechanical components, in operando characterization of operational devices or circuits, measuring amplitudes of electrical currents flowing in electrical wires or circuit traces, or any combination thereof.

In some aspects, the structured product is disposed on a building material, machinery part, or other material, wherein the method detects temperature differences on the building material, machinery part, or other material for detecting cracks or weak points, detecting moisture, or a combination thereof, optionally wherein there is a temperature gradient in a direction perpendicular to a side of the building material, machinery part, or other material on which the structured product is disposed.

In some aspects, ultra-low temperature variation of a surface is sensed with a TIS-method. Such fine temperature features or tiny temperature variations often contains rich information of the target object in applications. In some aspects, the experimental temperature sensitivity is increased by 15 times from ˜45 mK (without TIS-coating) to ˜3 mK (with TIS-coating), though other increases are possible as described elsewhere herein.

In some aspects, a TIS-method may be used to (1) detect ultra-weak temperature variations that otherwise cannot be distinguished by conventional thermography; (2) capture spatially small thermal features; (3) achieve a higher SNR; (4) improve the temperature sensitivities or noise-equivalent differential temperatures (NEDT) of IR cameras; or (5) any combination thereof.

In some aspects, the structured product (TIS-coating) can be employed for medical thermography, including cancer screening, checking of musculoskeletal disorders, diagnosis of rheumatic diseases, dermatological applications, evaluation of transplantation, and imaging of brain activities. In some aspects, the structured product (TIS-coating) can be employed for IR imaging of blood vessels for intravascular sampling of venous blood, intravenous injections of drug solutions, monitor of health parameters such as blood pressure, and diagnostics of circulatory disorders. In some aspects, the structured product (TIS-coating) can be employed for night vision, security surveillance, electronics inspection, medical diagnostics, structural defect screening, and academic research.

In some aspects, abnormal temperature spots of skins are sensitively detected with TIS-method for medical diagnostics, such as early-stage cancer diagnostics. In some aspects, thermography is used to screen breast cancer prior to mammography testing, due to its advantages of low costs, and easy accessibility. Since TIS-method can enable cancer screen at much earlier stages, increase SNR, and improve diagnostic sensitivity and specificity, it finds application in this field and thus potentially may improve the survival rate of patients. Also, TIS-method may be used to help determine the distribution and the size of cancer/tumor at an earlier stage. Similarly, TIS-method can also be used in the diagnostics of other cancers, tumors or other body activities that would create abnormal temperature profiles. It is noted that TIS-assisted thermography is not limited to human diagnostics: TIS-assisted thermographic diagnostics of animals are also applicable, such as domestic animals, horses, canines, dogs, felines, cats, hamsters, mice, zoo animals, elephants, giraffes, lions, tigers, zebras, deer, moose, and so forth.

In some aspects, TIS-method creates unprecedented fine temperature profiles of human body for various medical applications. IR imaging of blood vessels is of importance in the medical fields, such as intravascular sampling of venous blood. In some aspects, apart from intravascular sampling of venous blood, TIS-method assisted thermography may also find applications such as intravenous injections of drug solutions, monitor of health parameters (for example, blood pressure), and diagnostics of circulatory disorders. The ultra-high temperature sensitivity based on TIS-method finds further applications in most areas of medical thermography, including checking of musculoskeletal disorders, diagnosis of rheumatic diseases, dermatological applications, evaluation of transplantation, and imaging of brain activities.

In some aspects, the fine temperature distribution in electronic chips is mapped with TIS-method. This information is important in thermal budget designs and failure detection of electronic chips. In some aspects, the TIS-method may be used to locate the heating source in a packaged product or an electronic chip. Since many electronic failures lead to overheating, TIS-method may be used to inspect failed electronic or electric components. Also, the TIS-method may be used to accurately map the temperature distribution of an object, which is of great importance in thermal budget designs.

In some aspects, ultra-sensitive thermography based on the TIS-method resolves even small temperature variations in processors, which is directly related to their working conditions. In some aspects, monotonic increase of measured temperature indicate that TIS-method optimizes the temperature sensitivity in IR cameras as well as the SNR of IR images. In some aspects, thermography with TIS-coating is used in non-invasive inspection of the working condition of electronic chips. The working frequency or working conditions of a CPU can be probed by ultra-sensitive thermography realized by the TIS-method. In some aspects, TIS-method may assist thermal analysis of CPUs. TIS-method may also be used to rapidly inspect the working loads or working frequencies of electrical or mechanical components, as heavy working loads or high working frequencies will lead to higher local temperature in them.

In some aspects, the current flowing in traces and wires is observed by TIS-method. That is, the TIS-method non-invasively measures the amplitudes of electrical currents. In some aspects, the TIS-coating assisted thermography non-invasively and quantitatively measures the currents flowing in electrical wires or circuit traces. In some aspects, TIS-method can be used to non-invasively measure the amplitude of the current flowing in a wire or in a circuit trace, which is critical in the real-time characterization of operational electrical circuits.

In some aspects, tiny cracks in building structures are detected by sensitive thermography based on the TIS-method. In some aspects, thermography is used to find cracks in building materials or other materials, such as tools, metals, structures, and so forth. In some aspects, a temperature gradient across the wooden wall is employed, such as 3-4° C./cm. In some aspects, TR images with and without TIS-coating are captured, and with TIS-coating the two line-grooves can be distinguished at a point where their separation is much smaller. In some aspects, TIS may help improve thermography so that smaller cracks and moisture in buildings, bridges, structures and machinery parts can be easily found.

In some aspects, the structured product, TIS-coating and TIS-method can be used for any suitable application. Such suitable applications include, but are not limited to, those set forth in Table 1.

TABLE 1

| Category | Application | |
|---|---|---|
| Buildings, | Vehicles & | Vehicle identification in bad weather |
| vehicles and | machineries | Test of wind screen demisting |
| machineries | | efficiencies |
| | | Metallic part defect examination |
| | | Inspection of machineries and |
| | | electrical components |
| | Buildings & | Thermal isolation evaluation for |
| | structures | buildings |
| | | Bridge deck conditions check |
| | Exposed | Crack inspection |
| | cracks | |
| | High-level | Moisture detection in walls |
| | moisture | |
| Bio-medical | Tissue | Determination of tissue change in |
| | | goats |
| | | Detection of brown adipose tissue in |
| | | humans |
| | | Detection of breast cancer in humans |
| Electronics | CPU | Temperature measurement of |
| | | processors |
| | Circuit | Flip chip solder joint inspection |
| | defects | Screening of failed vias in PCB |
| Microbiology | Single-cell | Probing temperature variations in cells |
| | thermography | |

Various aspects are contemplated herein, several of which are set forth in the paragraphs below. It is explicitly contemplated that any aspect below, or any portion thereof, can be combined to form an aspect.

Aspect 1: a structured product, comprising:
at least two layers comprising a first layer and a second layer;
wherein:
the first layer comprises at least one material having a temperature-dependent (e.g., a positive temperature-dependent or a negative temperature-dependent) wavelength-integrated emissivity (ε);
the second layer comprises at least one reflective material that is reflective to light in an IR spectrum, optionally in an 8-14 μm wavelength range; and
the structured product has a positive temperature-dependent or a negative temperature-dependent wavelength-integrated emissivity.

Aspect 2: the structured product of any preceding aspect, wherein the at least one material comprises vanadium dioxide, germanium-antimony-tellurium, or a combination thereof.

Aspect 3: the structured product of any preceding aspect, wherein the at least one material is doped with tungsten, chromium, gallium, aluminum, or any combination thereof.

Aspect 4: the structured product of any preceding aspect, wherein the at least one material comprises tungsten-doped vanadium dioxide having a formula of WₓV₁₋ₓO₂, wherein x is 0-5%, 0.1-2%, or 1-1.5%.

Aspect 5: the structured product of any preceding aspect, wherein, within a temperature range of −100 to 100° C., the at least one material has a wavelength-integrated emissivity temperature-dependence of at least 0.01 per ° C., at least 0.05 per ° C., at least 0.1 per ° C., or at least 0.2 per ° C., wherein the wavelength-integrated emissivity is integrated over a wavelength range of 8-14 μm.

Aspect 6: the structured product of any preceding aspect, wherein the wavelength-integrated emissivity is between 0.3 to 1, wherein the wavelength-integrated emissivity is integrated over a wavelength range of 8-14 μm.

Aspect 7: the structured product of any preceding aspect, wherein the at least one material exhibits a thermally-triggered phase transition from an insulating phase to a metallic phase when temperature is increased, and optionally wherein the phase transition is reversible.

Aspect 8: the structured product of aspect 7, or any preceding aspect, wherein, in a temperature range of 20-60° C., the thermally-triggered phase transition results in an increase in the wavelength-integrated emissivity of at least 0.2, wherein the wavelength-integrated emissivity is integrated over a wavelength range of 8-14 μm.

Aspect 9: the structured product of aspect 7 or aspect 8, or any preceding aspect, wherein the thermally-triggered phase transition occurs in a temperature range of −100° C. to 100° C., 10° C. to 80° C., 20° C. to 70° C., or 20° C. to 50° C.

Aspect 10: the structured product of any one of aspects 7-9, or any preceding aspect, wherein, in a 8-14 μm wavelength region, the metallic phase absorbs more light than the insulating phase.

Aspect 11: the structured product of any preceding aspect, wherein the at least one reflective material comprises a metallic material, a ceramic, an artificial photonic structure, or a combination thereof.

Aspect 12: the structured product of aspect 11, or any preceding aspect, wherein the metallic material comprises gold, silver, aluminum, tungsten, platinum, chromium, titanium, copper, ruthenium, alloys thereof, or any combination thereof.

Aspect 13: the structured product of aspect 11 or aspect 12, or any preceding aspect, wherein the ceramic comprises indium tin oxide, M-phase vanadium dioxide, TiN, SrRuO₃, or any combination thereof.

Aspect 14: the structured product of any one of aspects 11-13, or any preceding aspect, wherein the artificial photonic structure comprises a metamaterial, a photonic crystal, a stacking layer, or any combination thereof.

Aspect 15: the structured product of any preceding aspect, further comprising at least one dielectric material.

Aspect 16: the structured product of aspect 15, or any preceding aspect, wherein the at least one dielectric material has a transmittance of at least 25% to light in a wavelength range of 8-14 μm.

Aspect 17: the structured product of aspect 15 or aspect 16, or any preceding aspect, wherein the first layer further comprises the at least one dielectric material.

Aspect 18: the structured product of any one of aspects 15-17, or any preceding aspect, wherein the at least one material is dispersed in or on the at least one dielectric material.

Aspect 19: the structured product of aspect 18, or any preceding aspect, wherein the dispersed material is in the form of a cube array structure, a cube array metamaterial structure, a hole array structure, a particle structure, a nanoparticle structure, a microparticle structure, a nanostructure, a fabricated nanostructure, a photonic structure, a fabricated photonic nanostructure, or any combination thereof.

Aspect 20: the structured product of any one of aspects 15-19, or any preceding aspect, wherein the structured product further comprises a third layer disposed between the first and second layers, wherein the third layer comprises the at least one dielectric material.

Aspect 21: the structured product of any one of aspects 18-20, or any preceding aspect, wherein, when the at least one material is in a metallic phase, at least one of the following is satisfied:
(a) components of the dispersed material are spaced from each other such that a quarter wavelength photonic resonance cavity is formed with light having a wavelength of 8-14 μm;
(b) the dispersed material in or on the first layer is spaced from the at least one reflective material such that a quarter wavelength photonic resonance cavity is formed with light having a wavelength of 8-14 μm;
(c) the first layer comprises a continuous film of the at least one material, and the continuous film is spaced from the at least one reflective material such that a quarter wavelength photonic resonance cavity is formed with light having a wavelength of 8-14 μm; or
(d) any combination thereof.

Aspect 22: the structured product of any one of aspects 15-21, or any preceding aspect, wherein the at least one dielectric material comprises at least one metal halide, at least one metal selenide, at least one semiconductor material, at least one polymer, or any combination thereof.

Aspect 23: the structured product of aspect 22, or any preceding aspect, wherein the at least one metal halide comprises barium fluoride, magnesium fluoride, calcium fluoride, beryllium fluoride, strontium fluoride, potassium fluoride, potassium bromide, potassium chloride, potassium iodide, sodium chloride, sodium fluoride, sodium bromide, sodium iodide, cesium iodide, or any combination thereof.

Aspect 24: the structured product of aspect 22 or aspect 23, or any preceding aspect, wherein the at least one metal selenide comprises zinc selenide, gallium(II) selenide, indium(III) selenide, sodium selenide, cadmium selenide, lead selenide, copper selenide, or any combination thereof.

Aspect 25: the structured product of any one of aspects 22-24, or any preceding aspect, wherein the at least one semiconductor material comprises zinc sulfide, germanium, silicon, thallium bromoiodide KRS-5, gallium arsenide, cadmium telluride, germanium-antimony-tellurium, amorphous germanium-antimony-tellurium, or any combination thereof.

Aspect 26: the structured product of any one of aspects 22-25, or any preceding aspect, wherein the at least one polymer comprises polyethylene, silicone, polycarbonate, poly(methyl)(meth)acrylate, polyethylene terephthalate, polyvinyl chloride, polypropylene, styrene-acrylonitrile copolymer, polystyrene, polytetrafluoroethylene, poly(vinylidene fluoride-cohexafluoropropene) (P(VdF-HFP)HP), hierarchically porous poly(vinylidene fluoride-cohexafluoropropene) (P(VdF-HFP)HP), any copolymer thereof, or any combination thereof.

Aspect 27: the structured product of any one of aspects 20-26, or any preceding aspect, wherein the structured product comprises a trilayer structure, wherein the first layer comprises WₓV₁₋ₓO₂, the second layer comprises the at least one reflective material, and the third layer comprises the at least one dielectric material, wherein x is 0-5% or 1-1.5%, and wherein the third layer is disposed between the first layer and the second layer.

Aspect 28: the structured product of any one of aspects 20-27, or any preceding aspect, wherein the structured product comprises a trilayer structure, wherein the first layer comprises WₓV₁₋ₓO₂, the second layer comprises barium fluoride, and the third layer comprises aluminum, wherein x is 0-5% or 1-1.5%, and wherein the second layer is disposed between the first layer and the third layer.

Aspect 29: the structured product of any preceding aspect, wherein the first layer has a thickness of 1-500 nm, 20-200 nm, 30-150 nm, 50-125 nm, 75-110 nm, 20-50 nm, or 25-40 nm.

Aspect 30: the structured product of any preceding aspect, wherein the first layer comprises a continuous film of the at least one material.

Aspect 31: the structured product of any preceding aspect, wherein the second layer has a thickness of 10-500 nm, at least 10 nm, at least 50 nm, at least 100 nm, 25-400 nm, 50-300 nm, or 75-200 nm.

Aspect 32: the structured product of any preceding aspect, wherein the second layer comprises a continuous film of the at least one reflective material.

Aspect 33: the structured product of any one of aspects 20-32, or any preceding aspect, wherein the third layer has a thickness of 0.01-10 μm, 1-2.5 μm, 0.5-5 μm, 0.8-4 μm, 1-3 μm, or 1.2-2 μm.

Aspect 34: the structured product of any one of aspects 20-33, or any preceding aspect, wherein the third layer has a thickness that satisfies the following equation:

d=(0.25×m×λ)/n

wherein d is thickness of the third layer, m is any integer greater than or equal to one, n is the real part of the refractive index of the third layer, and, is a resonance peak wavelength in a range of 8-14 μm.

Aspect 35: the structured product of any preceding aspect, further comprising a flexible substrate disposed on the first layer, the second layer, or both.

Aspect 36: the structure product of aspect 35, or any preceding aspect, wherein the flexible substrate is configured to conduct thermal energy to the at least one material.

Aspect 37: the structured product of aspect 35 or aspect 36, or any preceding aspect, further comprises an adhesive or glue disposed on a surface of the flexible substrate.

Aspect 38: the structured product of any one of aspects 35-37, or any preceding aspect, wherein the flexible substrate comprises a polymer tape, polyethylene tape, SCOTCH tape, KAPTON tape, woven fabric, nonwoven fabric, or any combination thereof.

Aspect 39: a method for thermal image sensitizing, the method comprising: imaging, in an infrared spectrum, the structured product of any preceding aspect.

Aspect 40: the method of aspect 39, or any preceding aspect, wherein the imaging is performed in a temperature range of −100° C. to 100° C., 10° C. to 80° C., 20° C. to 70° C., or 20° C. to 50° C.

Aspect 41: the method of aspect 39 or aspect 40, or any preceding aspect, wherein the imaging is performed in a wavelength range of 5-20 μm or 8-14 μm.

Aspect 42: the method of any one of aspects 39-41, or any preceding aspect, wherein the method increases temperature sensitivity by at least 2 times, at least 5 times, at least 10 times, or at least 15 times compared to a temperature sensitivity of an otherwise identical method that does not employ the structured product.

Aspect 43: the method of any one of aspects 39-42, or any preceding aspect, wherein the method resolves temperature differences of less than 45 mK, less than 40 mK, 1-40 mK, 1-30 mK, 1-10 mK, 1-5 mK, 3-15 mK, at least 3 mK, at least 4 mK, at least 5 mK, 3-5 mK, or 2-5 mK.

Aspect 44: the method of any one of aspects 39-43, or any preceding aspect, wherein the imaging step employs an infrared imaging device that indicates a temperature reading by assuming a constant wavelength-integrated emissivity, and the method further comprises:
calculating an actual temperature using the following equation:

$$\frac{{dT}_{IR}}{dT} = {( \frac{ε}{{ε}_{0}} )}^{1 / 4} ( 1 + \frac{1}{4} \frac{dln ε}{dlnT} )$$

wherein T_{IR} is the temperature reading, T is the actual temperature, ε₀ is the constant wavelength-integrated emissivity, and ε is an actual emissivity, and
optionally wherein the calculating step assumes dT_{IR}/dT is equal to (ε/ε₀)^{1/4}.

Aspect 45: the method of any one of aspects 39-44, or any preceding aspect, wherein the structured product is disposed on a surface, and the method detects temperature differences on the surface for sensing ultra-weak temperature variations, detecting spatially small thermal features, enhancing signal-to-noise compared to otherwise identical imaging without the structured product, or any combination thereof.

Aspect 46: the method of any one of aspects 39-44, or any preceding aspect, wherein the structured product is disposed on animal tissue, wherein the method detects temperature differences on the animal tissue for medical diagnostics, medical thermography, early stage cancer diagnostics, diagnosis of cancer, determining tumor size and distribution information, vasculature imaging, determining crossing points of veins or arteries, facilitating intravenous injections of drug solutions, monitoring health parameters, monitoring blood pressure, diagnostics of circulatory disorders, diagnostics of musculoskeletal disorders, diagnostics of rheumatic diseases, dermatological applications, evaluation of transplantation, imaging of brain activities, observing temperature variations in a cell, or any combination thereof.

Aspect 47: the method of any one of aspects 39-44, or any preceding aspect, wherein the structured product is disposed on a device, integrated circuit, electronic chip, or processor, wherein the method detects temperature differences on the device, integrated circuit, electronic chip, or processor for mapping fine temperature distributions, designing thermal budgets, inspecting failures, locating a heating source, resolving small temperature variations, non-invasive inspecting of working conditions, inspecting working loads, inspecting frequencies of electrical or mechanical components, in operando characterization of operational devices or circuits, measuring amplitudes of electrical currents flowing in electrical wires or circuit traces, or any combination thereof.

Aspect 48: the method of any one of aspects 39-44, or any preceding aspect, wherein the structured product is disposed on a building material, machinery part, or other material, wherein the method detects temperature differences on the building material, machinery part, or other material for detecting cracks or weak points, detecting moisture, or a combination thereof, optionally wherein there is a temperature gradient in a direction perpendicular to a side of the building material, machinery part, or other material on which the structured product is disposed.

Aspect 49: a method of making the structured product of any one of aspects 1-38, or any preceding aspect, the method comprising attaching the first layer directly or indirectly to the second layer.

Aspect 50: the method of aspect 49, or any preceding aspect, further comprising disposing the third layer between the first layer and the second layer.

Aspect 51: the method of aspect 49 or aspect 50, or any preceding aspect, further comprising adhering the first layer or the second layer to a flexible substrate.

Aspect 52: the method of any one of aspects 49-51, or any preceding aspect, wherein the structured product comprises a trilayer structure comprising the first layer, the second layer, and the third layer; the attaching step comprises indirectly attaching the first layer to the second layer, and the attaching step further comprises:
depositing the first layer on a sacrificial substrate,
forming the third layer on the first layer,
positioning the second layer on the third layer, thereby resulting in the trilayer structure,
optionally, transferring the trilayer structure to a flexible substrate, and
removing the sacrificial substrate.

Aspect 53: the method of aspect 52, or any preceding aspect, wherein at least one of the following is satisfied:
the at least one material comprises WₓV₁₋ₓO₂ wherein x is 0-5%, optionally wherein x is 1-1.5%;
the at least one dielectric material comprises a metal halide optionally comprising barium fluoride;
the at least one reflective material comprises silver;
the sacrificial substrate comprises borosilicate glass;
the depositing step comprises pulsed laser deposition, sputtering, wet chemistry, thermal evaporation, or any combination thereof,
the forming step comprises pulsed laser deposition, sputtering, wet chemistry, thermal evaporation, or any combination thereof,
the positioning step comprises pulsed laser deposition, sputtering, wet chemistry, thermal evaporation, or any combination thereof;
the removing step comprises etching;
a combination thereof, or
any combination thereof.

Aspect 54: a combination of any preceding aspect or portion thereof.

The following examples further illustrate the invention but, of course, should not be construed as in any way limiting its scope.

### Example 1

In this example, ultra-low temperature variation of a surface is sensed with a TIS-method. Such fine temperature features or tiny temperature variations often contains rich information of the target object in applications.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

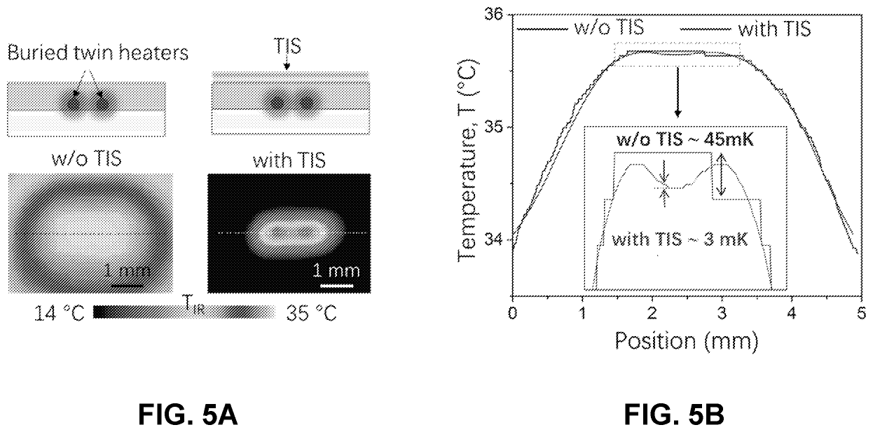

Two heaters, made of tiny W wires, are separated by 1 mm and attached onto a 2 cm×2 cm large, 2 mm-thick paper board. Subsequently, a few layers of black carbon tape (˜1 mm-thick in total) are then pasted onto the heaters. Note that the black carbon tape has a fixed E of 0.90-0.95. As shown in FIG. 5(a), upon direct IR imaging without TIS-coating, the thermal profile of two heaters cannot be recognized, while the two lobes of heaters are distinguishable when TIS-coating is applied to enhance the temperature sensitivity of the IR camera.

Due to the abrupt change of E in TIS-coating, the direct IR image with TIS-coating exhibits much lower IR imaging temperatures than the actual temperature. Therefore, to get the actual temperatures (T), the IR imaging temperature (T_{IR}) is calibrated back to T using the pre-measured T_{IR} versus T curves (FIG. 4). FIG. 5(b) depicts the comparison between actual temperature profiles with and without TIS-coating. Here, the difference between the center dip temperature and the two peak temperatures is distinguishable only with the TIS-coating. The experimental temperature sensitivity is increased by 15 times from ˜45 mK (without TIS-coating) to ˜3 mK (with TIS-coating).

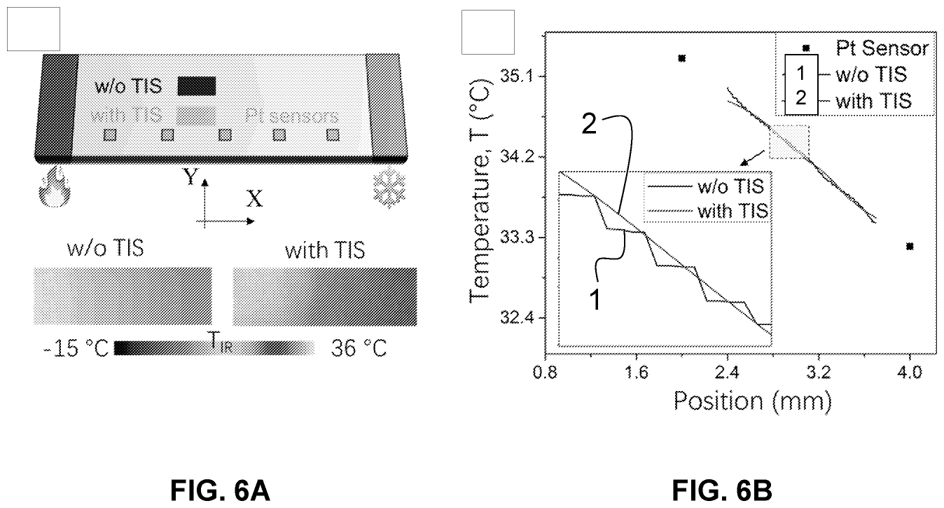

Another related aspect to sense ultra-weak temperature variation is as follows: A long copper plate is heated at one end while cooled at the other end to create a stable temperature gradient along the plate, as shown in FIG. 6(a). Platinum resistance temperature detectors (Heraeus Sensor Technology) are placed as a verification of the temperature gradient. A TIS-coating and a high-emissivity coating film are placed on the plate side-by-side, and they are subject to the same temperature gradient. Compared to the IR image without TIS-coating, the captured thermal profile with TIS-coating is much finer with less step features (which are caused by the temperature sensitivity limit of the IR camera). FIG. 6(b) is the comparison between actual temperatures captured without and with TIS-coating, which shows a great improvement in temperature sensitivity by the TIS-method.

This example demonstrates that, for practical applications, a TIS-method may be used to (1) detect, in a non-contact and non-invasive way, ultra-weak temperature variations that otherwise cannot be distinguished by conventional thermography; (2) capture spatially small thermal features; (3) achieve a higher SNR; (4) improve the temperature sensitivities or noise-equivalent differential temperatures (NEDT) of IR cameras; or (5) any combination thereof.

### Example 2

In this example, abnormal temperature spots of skins are sensitively detected with TIS-method for early-stage cancer diagnostics.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

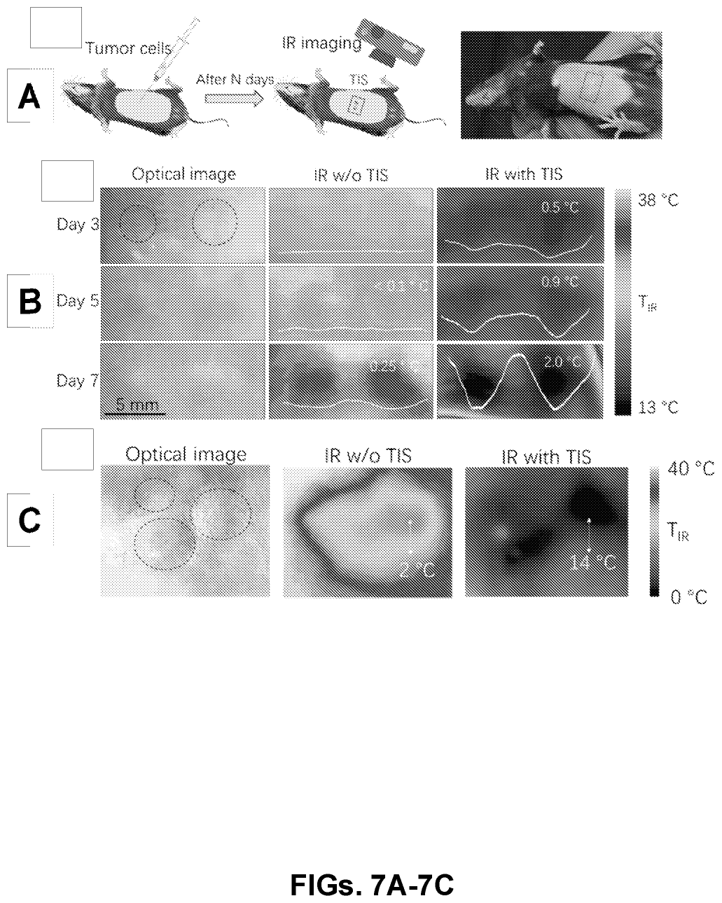

Thermography is widely applied in medical fields such as cancer detection, because the hypervascularity or impaired blood supplies in tumors always create abnormal local temperatures (higher or lower than normal tissues) which can be detected by IR cameras. RMA cells, belonging to the lymphoma cell line, are cultured in RPMI 1640 (ThermoFisher Scientific) and washed and resuspended in PBS (ThermoFisher Scientific). Then, they are subcutaneously injected at two near spots on the belly of C57BL/6J mice. The RMA dose is ˜10⁵ cells in a total volume of 50 μL at each injection site. Optical images and IR images (with and without the TIS-coating) are captured on a regular basis (FIG. 7(a)).

The results are shown in FIG. 7(b). On the 3^{rd} day after injection, no features can be recognized in the optical image and the IR image without TIS-coating. However, two obvious cold spots can be observed in the IR image with TIS-coating at the injection spots. On the 5^{th} day, the tumors continue to grow, and can be barely seen in both the optical image and the IR image without TIS-coating. Meanwhile, the cold spots in the IR image with TIS-coating become larger and clearer. On day 7 after injection, the tumors are so large that all imaging approaches have the identical diagnostics of the two tumors, and their consistency further proves the fidelity of TIS-method assisted thermography.

Then, the RMA cells are subcutaneously injected at three near spots on the belly of C57BL/6J mice (FIG. 7(c)). The IR image taken later without TIS-coating can only observe one large cold spot, while three tumor spots cannot be distinguished. On the contrary, in the IR image taken with TIS-coating on the same day, three injection spots are distinguishable as three separate cold spots.

This example demonstrates that, for practical applications, thermography can be used to screen breast cancer prior to mammography testing, due to its advantages of low costs, and easy accessibility. Since TIS-method can enable cancer screen at much earlier stages, increase SNR, and improve diagnostic sensitivity and specificity, it finds application in this field and thus potentially may improve the survival rate of patients. Also, TIS-method may be used to help determine the distribution and the size of cancer/tumor at an earlier stage. Similarly, TIS-method can also be used in the diagnostics of other cancers, tumors or other body activities that would create abnormal temperature profiles. It is noted that TIS-assisted thermography is not limited to human diagnostics: TIS-assisted thermographic diagnostics of animals are also applicable, such as domestic animals, horses, canines, dogs, felines, cats, hamsters, mice, zoo animals, elephants, giraffes, lions, tigers, zebras, deer, moose, and so forth.

### Example 3

In this example, a TIS-method creates unprecedented fine temperature profiles of human body for various medical applications.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

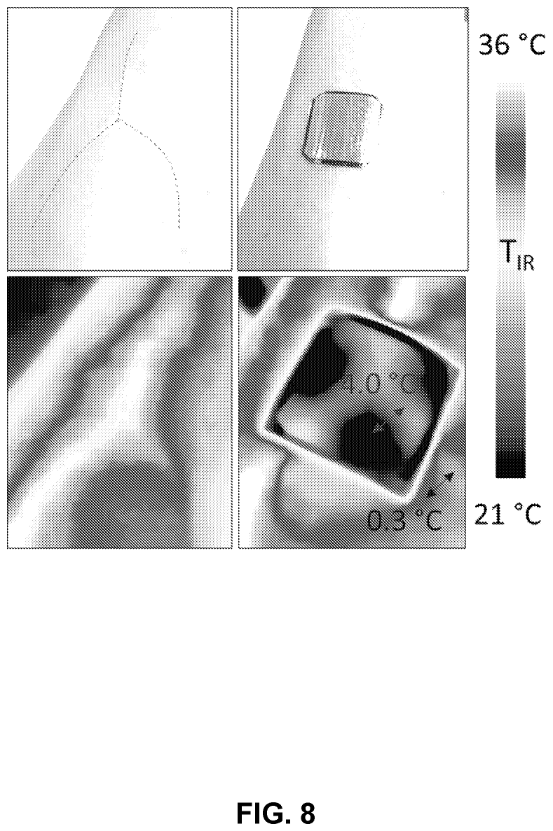

IR imaging of blood vessels is of importance in the medical fields, such as intravascular sampling of venous blood. First, direct IR imaging of a forearm fails to resolve the crossing point of veins. Next, the forearm is covered with a piece of TIS-coating, then the IR imaging is conducted again. The IR image captured with TIS-coating clearly shows the crossing point of the veins in the forearm (FIG. 8).

This example demonstrates that, for practical applications, apart from intravascular sampling of venous blood, TIS-method assisted thermography may also find applications such as intravenous injections of drug solutions, monitor of health parameters (for example, blood pressure), and diagnostics of circulatory disorders. The ultra-high temperature sensitivity based on TIS-method finds further applications in most areas of medical thermography, including checking of musculoskeletal disorders, diagnosis of rheumatic diseases, dermatological applications, evaluation of transplantation, and imaging of brain activities.

### Example 4

In this example, the fine temperature distribution in electronic chips is mapped with TIS-method. This information is important in thermal budget designs and failure detection of electronic chips.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

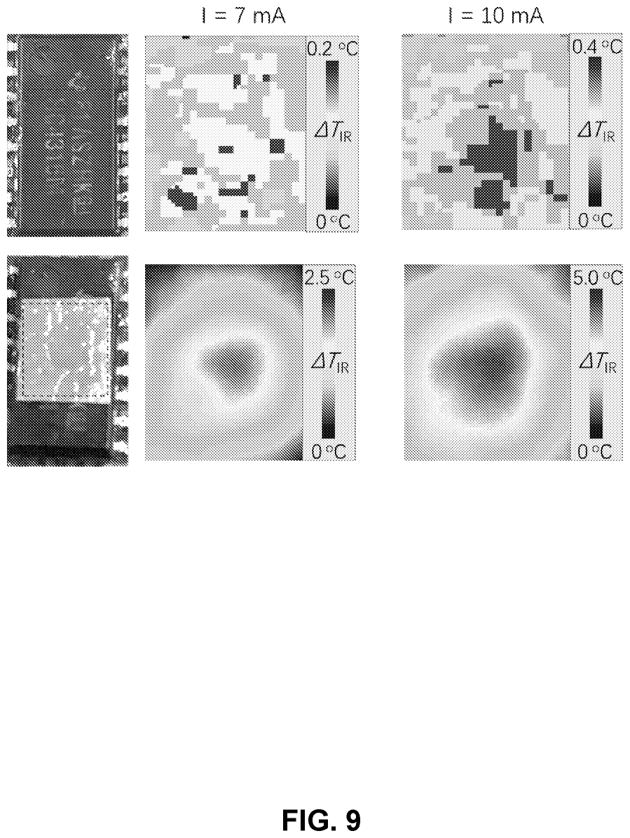

A TS3A44159 quad single pole double throw (SPDT) analog switch chip (Texas instruments) is used for the demonstration. An electrical current (7 mA or 10 mA), flowing through the port COM1 to the port NC1, heats up the chip. When the current is relatively weak, the temperature increase in the chip is too small to be clearly imaged by IR cameras, as shown in FIG. 9. However, with TIS-coating, the thermal profile can be obviously recorded.

This example demonstrates that, for practical applications, the TIS-method may be used to locate the heating source in a packaged product or an electronic chip. Since many electronic failures lead to overheating, TIS-method may be used to inspect failed electronic or electric components. Also, the TIS-method may be used to accurately map the temperature distribution of an object, which is of great importance in thermal budget designs.

### Example 5

In this example, ultra-sensitive thermography based on the TIS-method resolves even small temperature variations in processors, which is directly related to their working conditions.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

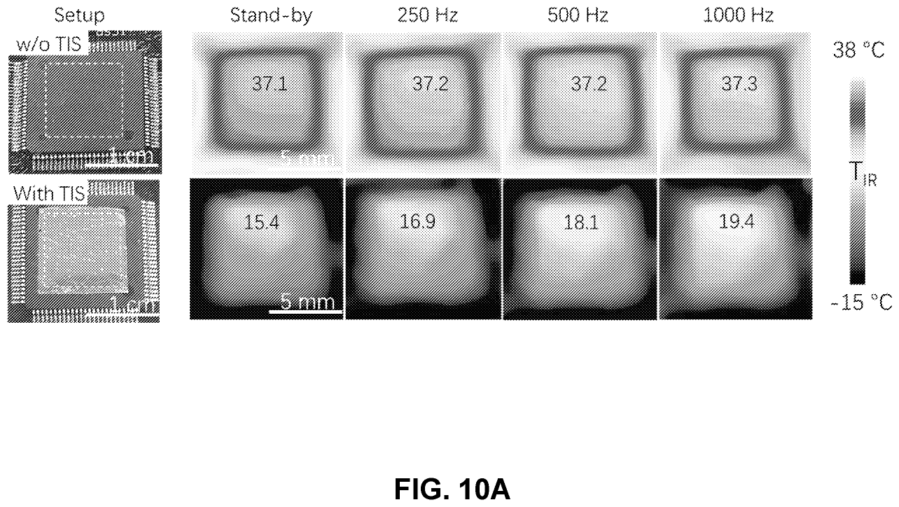

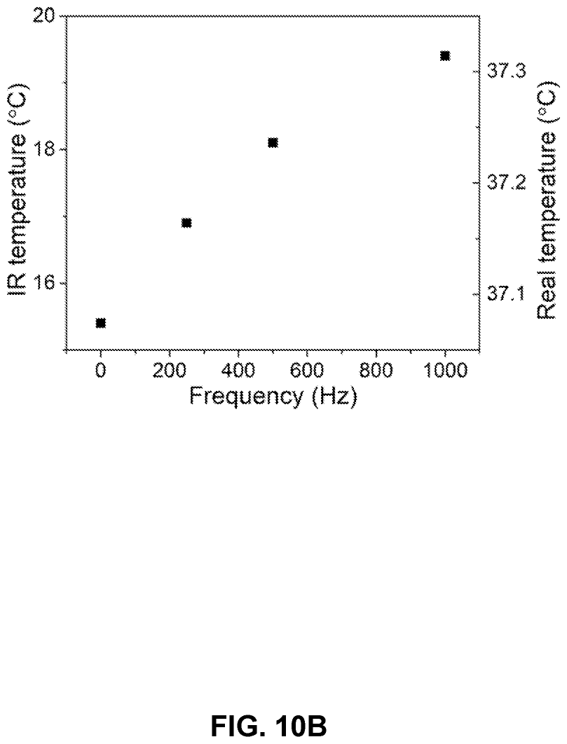

The processor unit of an Arduino Mega 2560 development board is controlled to repeatedly sense its local temperature and then adjust the output voltage accordingly at certain operation frequencies. Note that in FIG. 10(a), the frequencies are temperature sensing frequencies of the processor, while the “stand-by” means that the process is not sensing or exporting any temperature data, i.e. 0 Hz frequency. A higher working frequency leads to higher Joule heating power and thus a higher local temperature in the processor. IR images of the processor unit with and without TIS-coating are captured. The IR images taken without TIS-coating have negligible temperature changes. In contrast, the IR imaging with TIS-coating clearly and accurately reflected the temperature increase. In FIG. 10(b), the maximum IR/real temperature measured with TIS assistance is plotted versus the processor working frequency. First, the monotonic increase of measured temperature indicates that TIS-method optimizes the temperature sensitivity in IR cameras as well as the SNR of IR images. Secondly, this aspect also illustrates that thermography with TIS-coating can be used in non-invasive inspection of the working condition of electronic chips. The working frequency or working conditions of a CPU can be probed by ultra-sensitive thermography realized by the TIS-method.

This example demonstrates that, for practical applications, the TIS-method may assist thermal analysis of CPUs. TIS-method may also be used to rapidly inspect the working loads or working frequencies of electrical or mechanical components, as heavy working loads or high working frequencies will lead to higher local temperature in them.

### Example 6

In this example, the current flowing in traces and wires is observed by TIS-method. That is, the TIS-method non-invasively measures the amplitudes of electrical currents.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

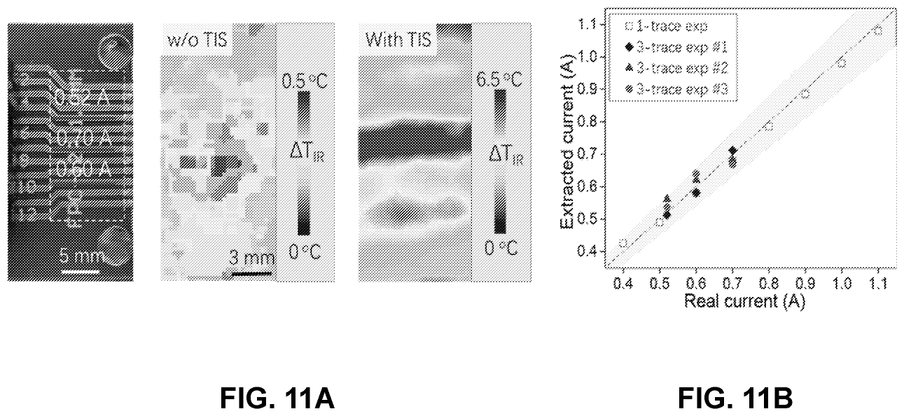

The TIS-coating assisted thermography non-invasively and quantitatively measures the currents flowing in electrical wires or circuit traces. One demonstration is depicted in FIG. 11, where a printed circuit board (PCB) with parallel copper circuit traces (Uxcell) is used. The width of traces and the gap between adjacent traces are both 0.5 mm. Three current traces are heated up by different currents flowing in them (FIG. 11(a)). Without TIS-coating, direct IR imaging only leads to maps of noise. However, when the PCB is covered by TIS-coating, IR images are able to accurately reflect the minute local temperature increase due to Joule heating, which can be used to calculate the amplitude of currents in those traces. FIG. 11(b) is the representative results, where 1-trace experiment denotes the demonstration where only one single circuit trace is heated by current, while 3-trace experiment means three traces are heated simultaneously, like the one shown in FIG. 11(a). It is noted that, using TIS-method, all current calculation results are accurate and are within a ±10% error range.

This example demonstrates that, for practical applications, TIS-method can be used to non-invasively measure the amplitude of the current flowing in a wire or in a circuit trace, which is critical in the real-time characterization of operational electrical circuits.

### Example 7

In this example, tiny cracks in building structures are detected by sensitive thermography based on the TIS-method.

This example employs a TIS-coating with a WₓV₁₋ₓO₂/BaF₂/Ag structure (FIG. 2), though other compositions, materials, or other options may be employed as described elsewhere herein, and thus these aspects are not intended to be limiting in any way.

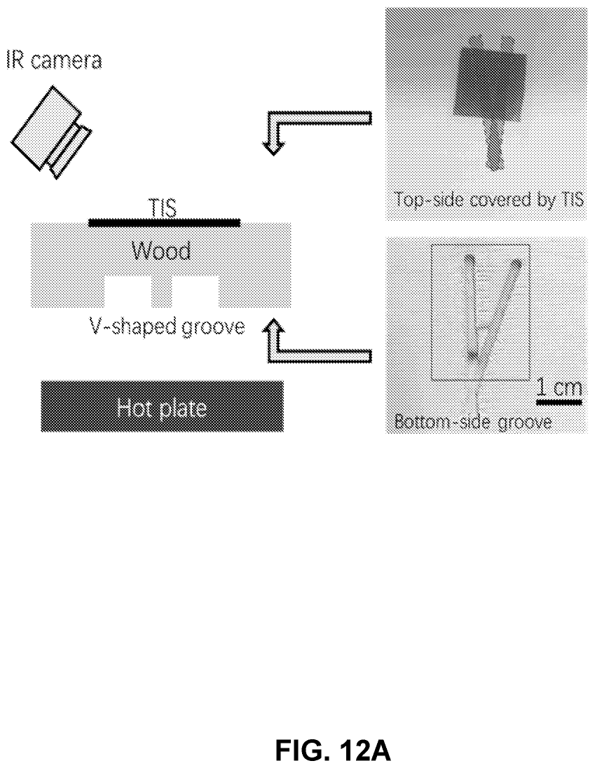

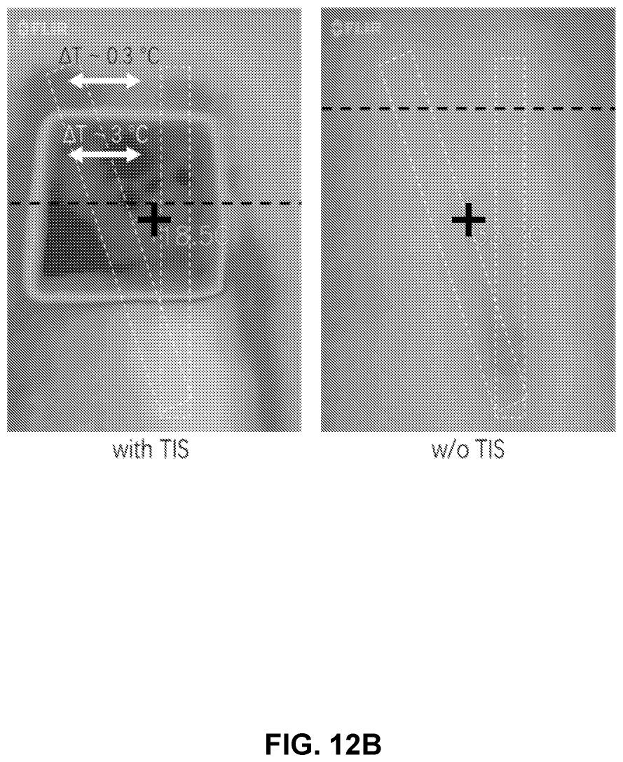

Thermography is used to find cracks in building materials. A 3 mm-deep V-shaped groove is created on the back surface of a 5 mm-thick wood plate. Then the plate is suspended, with the groove facing down, above a hot plate to create a ˜5° C./cm temperature gradient across the wood plate (FIG. 12(a)). This setup is to imitate real wall of a building whose interior space is warmed up with a temperature gradient of 3-4° C./cm across the wooden wall. IR images with and without TIS-coating are captured. With TIS-coating, the two line-grooves can be distinguished at a point where their separation is much smaller. Also, the V-shaped groove is much clearer in the IR image with TIS-coating (FIG. 12(b)).

This example demonstrates that, for practical applications, TIS may help improve thermography so that smaller cracks and moisture in buildings, bridges, structures and machinery parts can be easily found.

### Example 8

This example describes millikelvin-resolved ambient thermography.

### Abstract:

Thermography detects surface temperature and sub-surface thermal activity of an object based on the Stefan-Boltzmann law of thermal radiation. Impacts of the technology would be more far-reaching with finer thermal sensitivity, called noise-equivalent differential temperature (NEDT). Existing efforts to advance NEDT are all focused on improving registration of radiation signals with better cameras, driving the number close to the end of the roadmap at 20 to 40 milli-Kelvin (mK). In this work, we take a distinct approach of sensitizing surface radiation against minute temperature variation of the object. The emissivity of the thermal imaging sensitizer (TIS) rises abruptly at a pre-programmed temperature, driven by a metal-insulator transition in cooperation with photonic resonance in the structure. The NEDT is refined by over 15 times with the TIS to achieve single-digit milli-Kelvin resolution near room temperature, empowering ambient thermography for a broad range of applications such as in-operando electronics analysis and early cancer screening.

### One Sentence Summary:

A thermal imaging sensitizer based on metal-insulator transition empowers ambient thermography with milli-Kelvin resolution for broad applications.

### Introduction

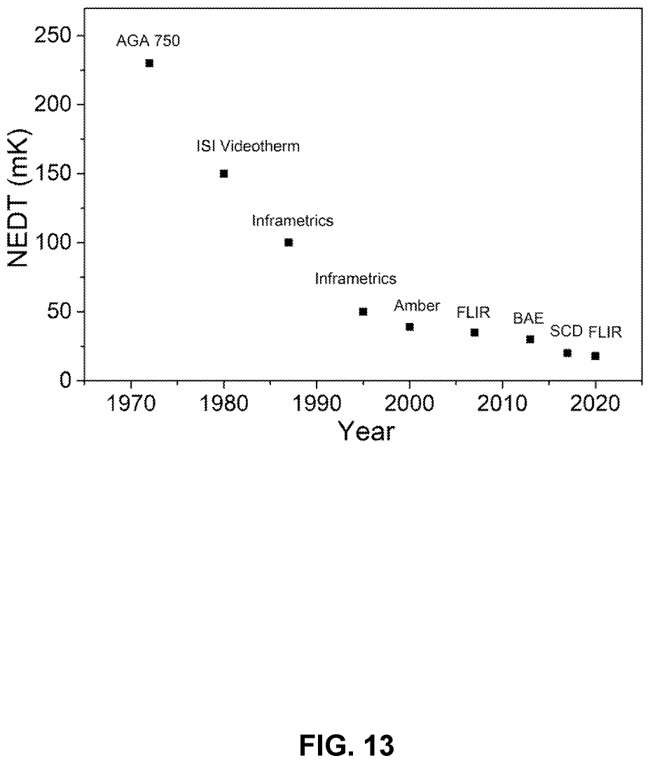

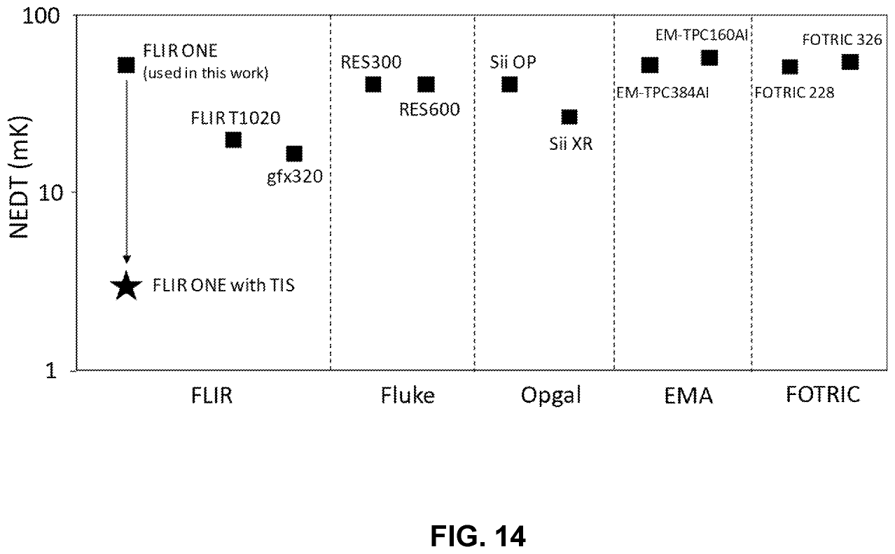

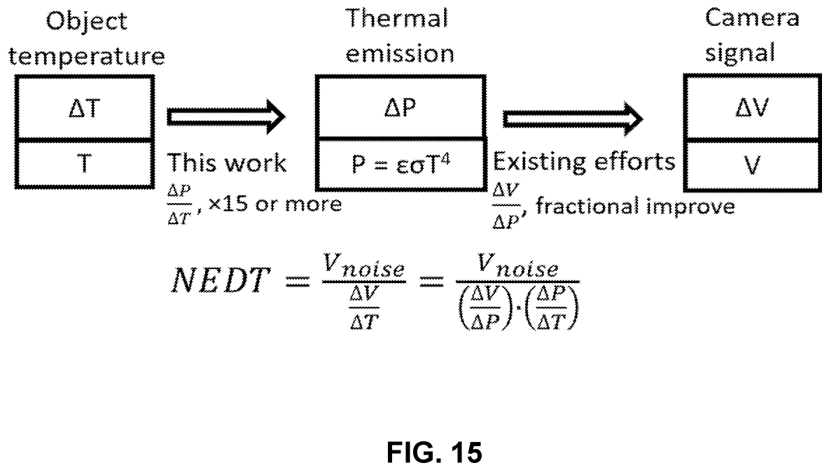

The Stefan-Boltzmann law states that the surface of conventional materials at temperature T emits infrared (IR) radiation with the radiated power (P_{rad}) proportional to T⁴. By calibrating the received P_{rad} using the T⁴ law, IR cameras image the temperature distribution on an object. The IR thermography at ambient finds diverse applications in fields ranging from night vision, security surveillance and electronics inspection to medical diagnostics, structural defect screening, and academic research. The noise-equivalent differential temperature (NEDT), one key figure of merit for these cameras, has been improved via better designs to enhance detection and conversion of P_{rad}, while assuming the T dependence of P_{rad} to be strictly bounded by the T⁴ law. Consequently, the roadmap of NEDT currently saturates at 20 to 40 mK for uncooled bolometers, with little advance in the past decades. In this work, in contrast, we turn to a distinct approach of lifting the limitation of the T⁴ law to improve NEDT by more than an order of magnitude (FIGS. 13 and 14). The IR camera generates the temperature reading (T_{IR}) by assuming a constant wavelength-integrated emissivity (ε₀) for the object. In the case when the actual emissivity (ε) is different from ε₀, T_{IR} deviates from the actual temperature T via P_{rad}=ε₀σ_{IR}⁴=εσT⁴,

$$σ = \frac{2 {π}^{5} {k}_{B}^{4}}{15 {c}^{2} {h}^{3}}$$

is the Stefan-Boltzmann constant. The differentiation of T_{IR} over T is:

$$\frac{{dT}_{IR}}{dT} = {( \frac{ε}{{ε}_{0}} )}^{1 / 4} ( 1 + \frac{1}{4} \frac{dln ε}{dlnT} ) , \qquad ( 1 )$$

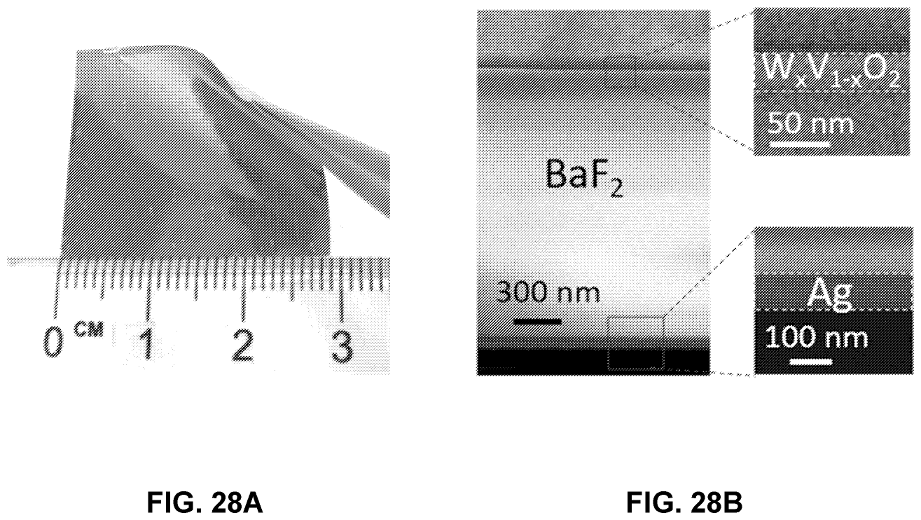

and is assumed to be equal to (ε/ε₀)^{1/4} as of conventional materials is nearly T-independent. However, dT_{IR}/dT would be much higher if e becomes strongly dependent on T, drastically amplifying small variations in T. In this work, the strong, positive T-dependence of ε is realized by integrating the metal-insulator transition (MIT) of tungsten-doped vanadium dioxide (WₓV₁₋ₓO₂) with a photonic cavity structure (FIG. 3). ε switches to a much higher value when T rises above the transition temperature, boosting dT_{IR}/dT and refining NEDT by a factor over 15 (FIGS. 1A and 1C). The device, coined as thermal imaging sensitizer (TIS), is fabricated on a thin flexible substrate, and can be conveniently and repeatedly applied to and peeled off from the object surface, as shown in FIG. 3 and FIG. 28A.

### Results:

The function of TIS builds on the well-known MIT of the strongly correlated electron material WₓV₁₋ₓO₂ at the temperature T_{MIT}≈67° C.-24° C.·x·100, which can be conveniently tuned from 67° C. to −100° C. by varying the composition x. In the insulating (I) state, the material is basically transparent to IR in the 8-14 μm wavelength range, and incoming IR radiation will penetrate through the top two layers with negligible absorption and reflected by the Ag mirror, as shown in FIG. 3. In contrast, when the WₓV₁₋ₓO₂ switches to the metallic (M) state, it becomes highly absorptive to IR radiation, and the absorption is further enhanced by the photonic resonance around wavelength of 9.8 μm in the designed ¼-wavelength cavity. Consequently, the system will go through an abrupt increase in absorbance (A) and hence emissivity, according to the Kirchhoff's law of radiation.

The sensitizing function of TIS is first characterized by imaging from an IR camera. FIG. 4 plots T_{IR} as a function of Tin the upper panel, called the sensitizing property curve (SPC), for three selected TIS's with W fractions of 1.5%, 1.3% and 1.1%. These samples exhibit sharp increase of T_{IR} at T˜28° C., 34° C., and 39° C., respectively, corresponding to the designed T_{MIT} of the WₓV₁₋ₓO₂ layer. Because T_{MIT} can be pre-set by the W fraction x, the T_{MIT} of TIS, along with its working temperature range, can be precisely designed to fit various applications.

The high dT_{IR}/dT enables drastic improvement of NEDT when taking IR images of objects coated with TIS, removing the artificial step features on the temperature profile while preserving good fidelity (FIGS. 6A and 6B). The power of TIS is further demonstrated by the “Rayleigh criterion”-like experiment in FIG. 5A. Here two small heaters were placed close to each other on a substrate. When imaged with a conventional IR camera, the twin-heater thermal feature cannot be resolved, whereas they become clearly distinguishable when imaged with the TIS coating. Note that for TIS-assisted IR imaging, T_{IR} recorded is not the actual temperature (T); but it could be readily calibrated back to T (FIG. 5B) using the SPC in FIG. 4 (details in Methods).

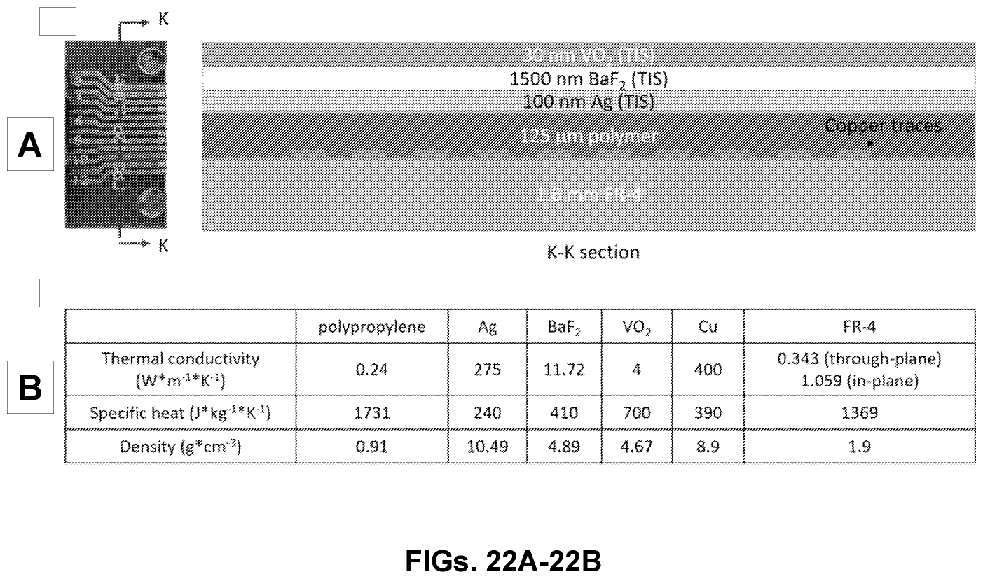

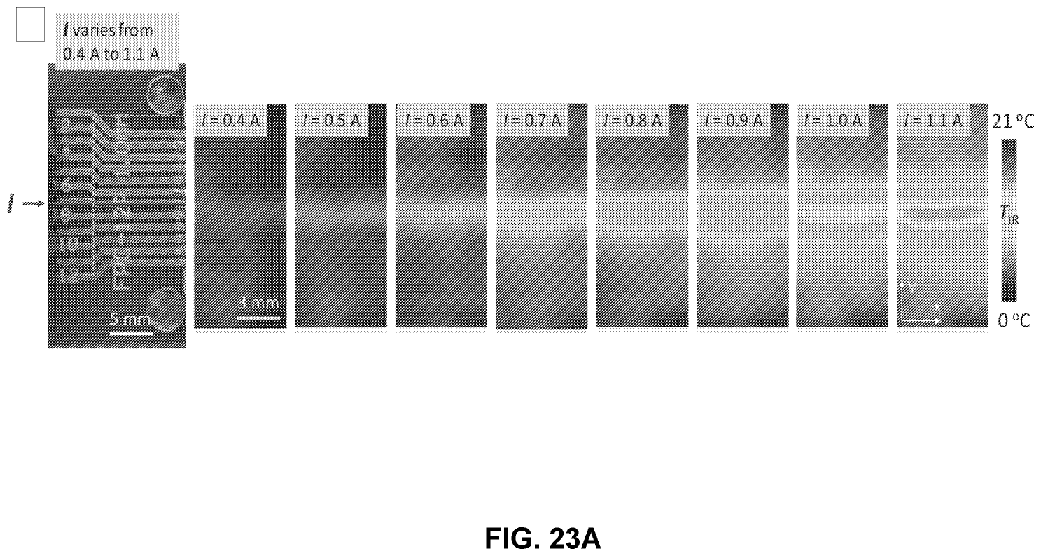

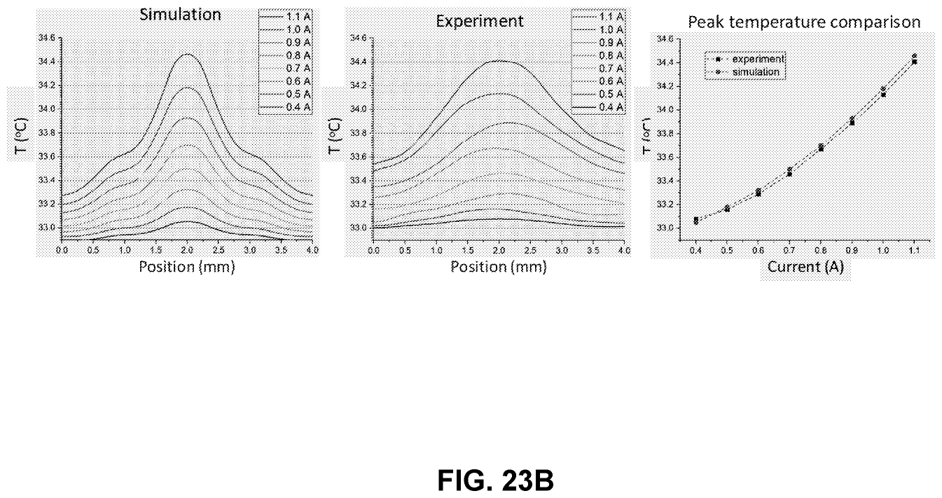

The significant reduction of NEDT greatly benefits thermal imaging of electronics. Ultra-sensitive passive thermal imaging can probe the operation status of electronic devices, and is especially useful for scenarios where lock-in amplification is not available. The over 15 times sensitization enables accurate detection of very weak thermal features in electronic circuits (see FIGS. 22A-22B and FIGS. 23A-23B). The TIS-assisted thermal imaging engenders a new technology that we call in-operando electronics analysis (oEA). The oEA extends the application of thermography from inspecting defective devices to normal devices in operation. By analyzing extremely weak thermal features on the surface of the device, oEA non-invasively “spies” on and reveals the working mode of the device in real time. FIG. 10A demonstrates thermographic differentiation of distinct workloads and operation modes of a CPU. The various input algorithms cause slightly different power generation and temperature patterns on the surface of the CPU, which are readily resolved with the TIS-assisted thermography.

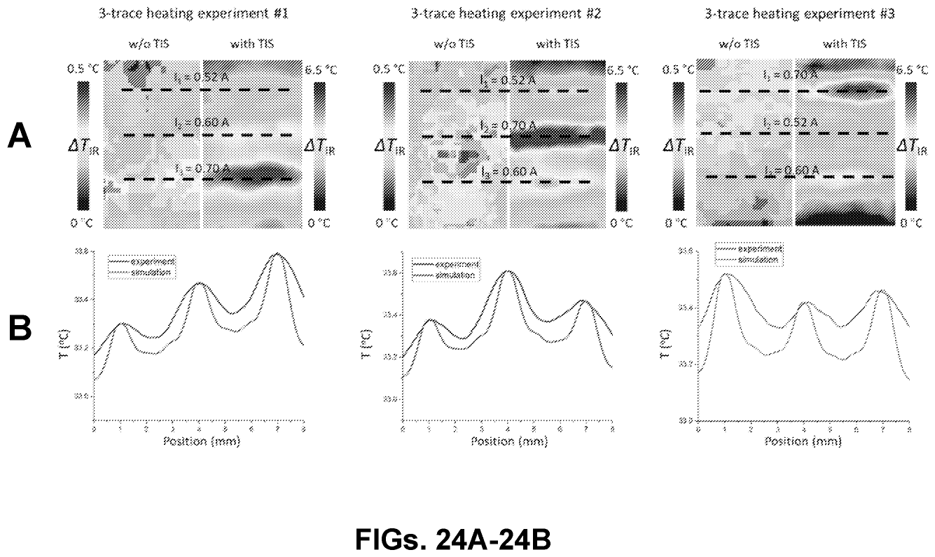

The oEA is further extended from qualitative probing to quantitative extraction of electronic operation parameters, such as electrical current flowing in wires and circuit traces (FIG. 11A). By calibrating local temperature rise from the Joule heating, the current levels in the circuit traces can be evaluated thermographically at high accuracy without interrogation with current meters. The operation can be performed simultaneously for multiple, adjacent traces on a circuit board, allowing non-invasive and quantitative current mapping. Based on thermal profiles calibrated with different currents in a single trace, the currents flowing in multiple traces on the PCB board are quantitatively determined with high accuracy (FIG. 11Bn, details in FIGS. 22A-22B, FIGS. 23A-23B and FIGS. 24A-24B).

The TIS also empowers groundbreaking advance in medical thermography. Thermography is broadly applied in areas such as cancer detection, diagnosis of diabetic neuropathy and vascular disorder, fever screening, dental care, and surgery. Breast cancer, for example, can be detected by IR cameras because hypervascularity in the tumors leads to slightly abnormal local temperature. With the advantages in cost, accessibility and non-invasiveness, thermography is used to screen breast cancer prior to mammography testing. However, current medical thermography suffers from the low diagnostic sensitivity and specificity, while TIS-assisted thermography would reduce noise, improve thermographic fidelity, and enable cancer screening at earlier stages, potentially improving the survival rate of patients.

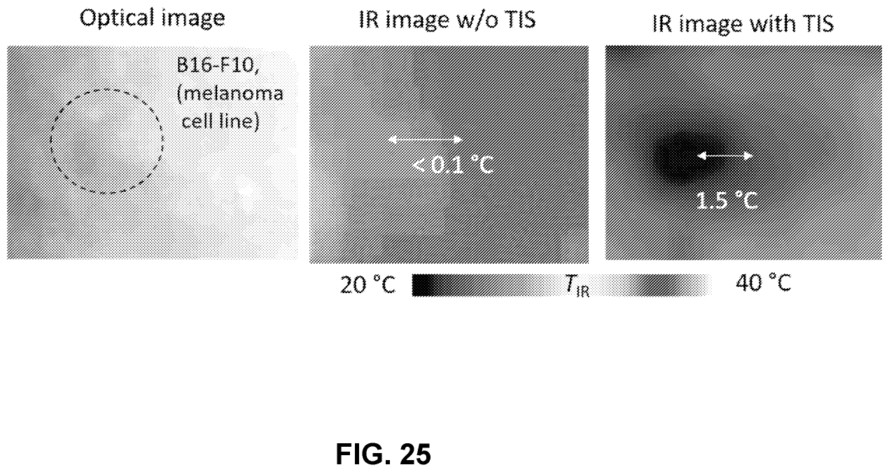

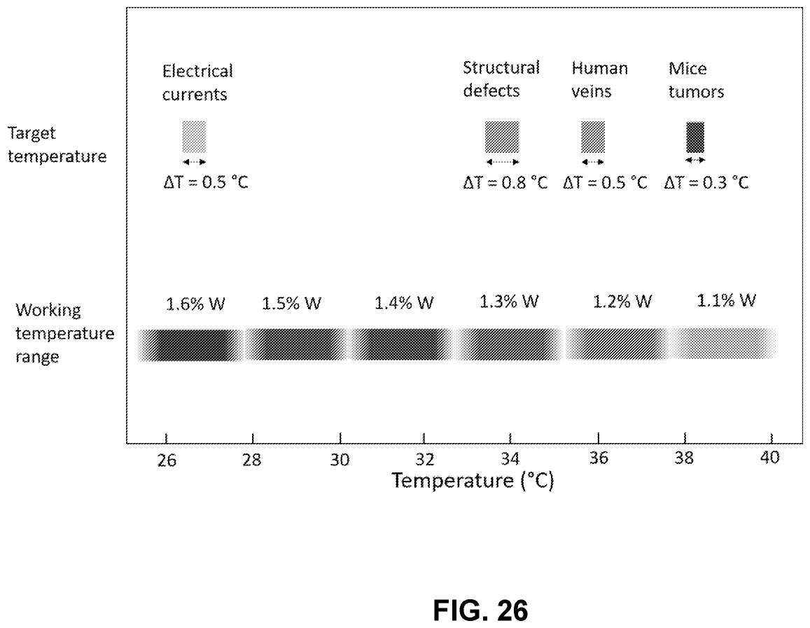

We demonstrate the benefit of TIS in subcutaneous cancer screening by tracking the growth of malignant tumors in mice. FIG. 7A shows the schematic of the experiment and the picture of a lab mouse. RMA cells, belonging to the lymphoma cell line, were injected at two near spots on the mouse belly to initiate the tumor growth. On different days after the injection, an optical image, an IR image without TIS, and an IR image with TIS were taken to characterize the tumor (FIG. 7B). On Day 3 after the cell injection, no features were detected in the optical or conventional IR imaging, while cold spots at the two tumors were clearly captured in the TIS-assisted IR imaging. As the tumors grow larger on Day 5, they could be barely observed visibly and by conventional IR imaging, while the IR imaging of the cold spots becomes much clearer and more confirmative with the TIS. On Day 7, the tumors are large enough to be detected in all imaging methods, and the consistency of these features validates the TIS-assisted imaging in the early stage of the tumor. As we show in FIG. 7C and FIG. 25, the benefit of TIS can be also extended to detecting other types of tumor cells, imaging the shape/size of tumors, and resolving multiple tumors when they are closely situated, similar to the scenario in FIG. 5B. The TIS can also be used in other medical thermography applications such as blood vessel imaging (FIG. 8).

For broader applications in practical scenarios, TIS is also open to improvements in multiple prospects by future endeavors. For example, more delicate control in the W doping of VO₂ will allow for finer tuning of the working temperature to optimize performance for various conditions. Doping with other elements like Ga or Al may shift the working temperature above that of pristine VO₂ (67° C.) to enable applications at higher temperature. Future engineering efforts to improve the quality of WₓV₁₋ₓO₂ can improve the sharpness of MIT and the reduction in NEDT, further boosting the performance in sensitivity and resolution. Finally, the response time of the device could be shortened by reducing the thickness of the flexible substrate film and improving the thermal contact with the target surface.

### Discussion

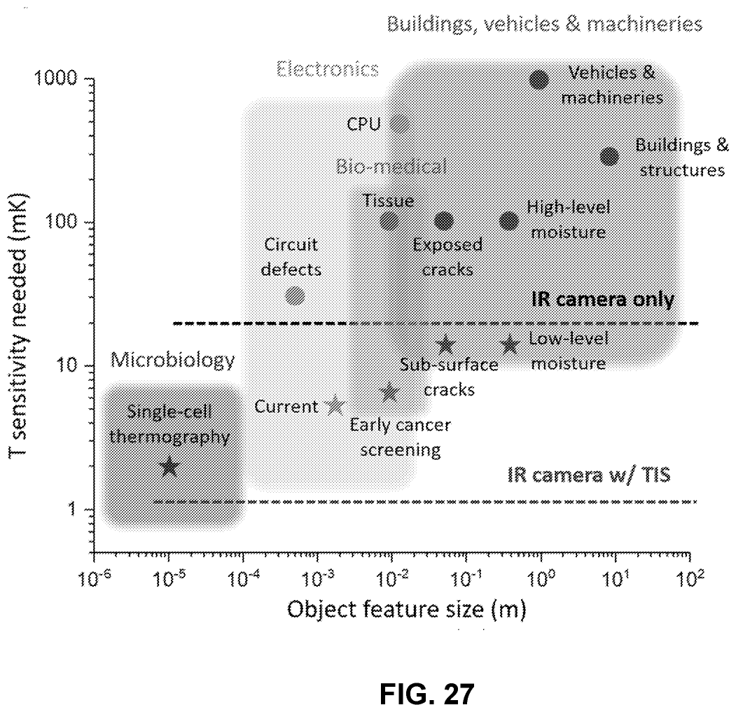

Integrating the thermally driven metal-insulator phase transition with a resonant photonic structure, we innovate ambient thermography by drastically refining the temperature sensitivity to single digits of milli-Kelvin. The TIS expands the applications of ambient thermography in electronics analysis and medical screening. As small temperature fluctuation exists over the surface of a wide range of objects and, in many cases, implicates unusual sub-surface thermal activities, the TIS is envisioned to broadly impact many other fields (FIG. 27). For example, at larger scales the TIS-assisted thermography may be used to inspect, image and monitor sub-surface cracks and stressed spots in buildings and bridges (FIG. 12); at smaller scales, with the aid of high-resolution IR microscopy, the TIS may act as functional templates on which biological activities of cells and microbes can be thermally imaged in real time.

### Materials and Methods

### Preparation of the TIS

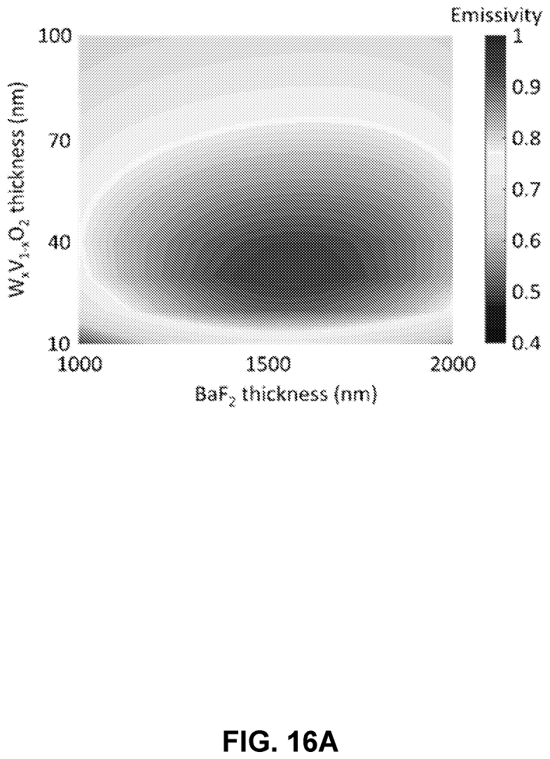

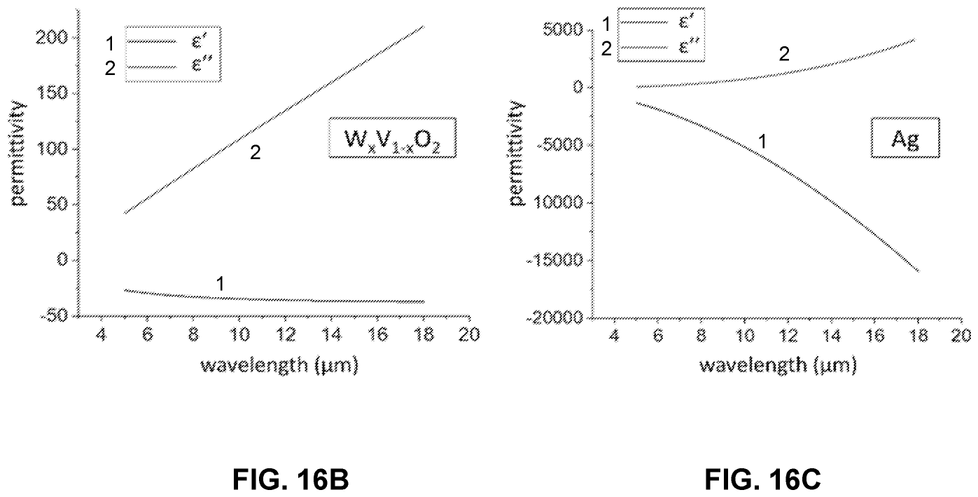

WₓV₁₋ₓO₂ thin films were grown on 170 μm thick borosilicate glass substrates using pulse laser deposition (PLD). The PLD targets were prepared by mixing WO₃ and V₂O₅ powders with W:V atomic ratio ranging from 1.1% to 1.5%, then made into 1 inch diameter round discs with a hydraulic press. All thin films were deposited in 5 mTorr O₂ environment at 570° C. substrate temperature, and the PLD laser energy was set at 321 mJ with 5 Hz pulse frequency. 30 nm of WₓV₁₋ₓO₂ was grown at a rate of 3 nm/min, followed by a post-deposition anneal at 570° C. for 30 mins in the same 5 mTorr O₂ environment. On top of the WₓV₁₋ₓO₂ films, 1.5 μm thick BaF₂ and 100 nm thick Ag layers were grown sequentially via thermal evaporation. The growth rates of BaF₂ and Ag were controlled at 20 Å/s and 2 Å/s, respectively. The thicknesses of the WₓV₁₋ₓO₂, BaF₂, and Ag layers were optimized for best optical performance with finite element method simulation using COMSOL Multiphysics (FIG. 16) and characterized by cross-sectional SEM imaging.

In the transfer process, a piece of 0.06 mm thick single-sided sticky scotch packaging tape was first carefully applied to fully cover the WₓV₁₋ₓO₂/BaF₂/Ag structure, where the Ag layer was stuck to the adhesive side without any residual air bubbles. The initial borosilicate glass substrate for thin film growth was then etched off by 49% Hydrofluoric (HF) acid in 5 mins. After the release process, the scotch tape with transferred WₓV₁₋ₓO₂/BaF₂/Ag structure was rinsed in deionized water and dried with a N₂ gun.

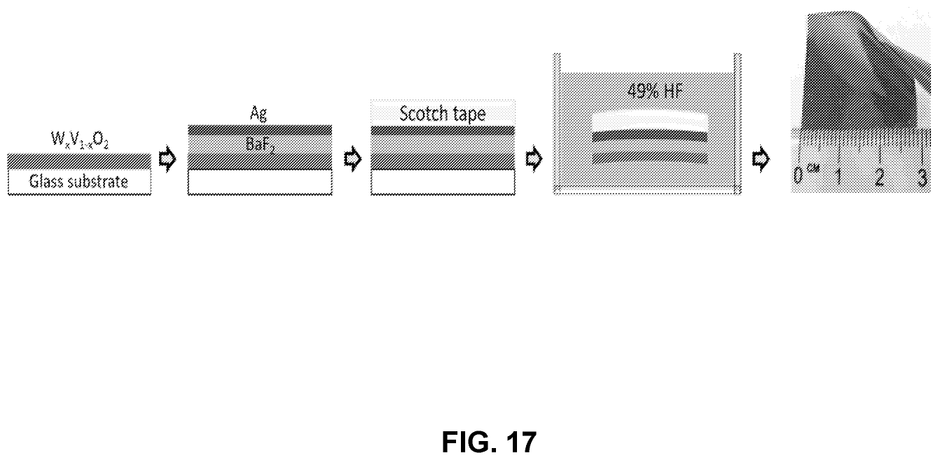

Detailed schematics and pictures of the process can be found in FIG. 17.

### IR Imaging and Analysis

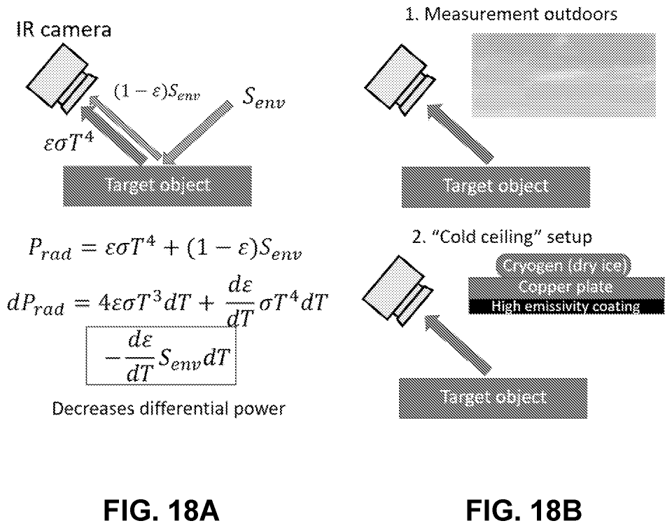

The IR images were captured by a FLIR ONE infrared (TR) camera working at a wavelength range of 8-14 μm, with a frame rate of 8.7 Hz. To minimize the reflection signals from the camera and the surroundings, the default viewing angle was set as 15° instead of normal incident direction, and the experiments were performed either in an open-area, outdoor environment under clear sky (cloud-free), or using a cold-plate setup. When doing experiments in outdoor environment, we avoid exposing the TIS and target surfaces to direct solar radiation, by setting up the system in the shadow of a building or blocking the sunlight with a solar shield. As described with more details in FIG. 18A and FIG. 18B, the cold-plate setup shows a similar effect comparable to experimenting in the outdoor environment.

When taking IR images, the camera measures the incident thermal radiation P_{rad}, and then gives the temperature reading (T_{IR}) assuming a constant emissivity for the target (e.g. ε₀=0.90, default setting of the camera, which applies to all images in this work). T_{IR} was plotted as a function of the real temperature T to generate the sensitization property curve (SPC). The sharp increase of T_{IR} at MIT is consistent with emissivity measurement by FTIR (FIG. 19A and FIG. 19B) and defines a high slope of dT_{IR}/dT up to 25. This means that an object with tiny, unresolvable ΔT on the surface would become easily resolvable by normal IR cameras if the object is covered with the TIS. For instance, ΔT of 20 mK is never resolved by an IR camera whose noise equivalent differential temperature (NEDT) is 45 mK. However, with the help of TIS, the same object will show up to 25 times higher ΔT_{IR} (500 mK) and is clearly resolved by the same IR camera.

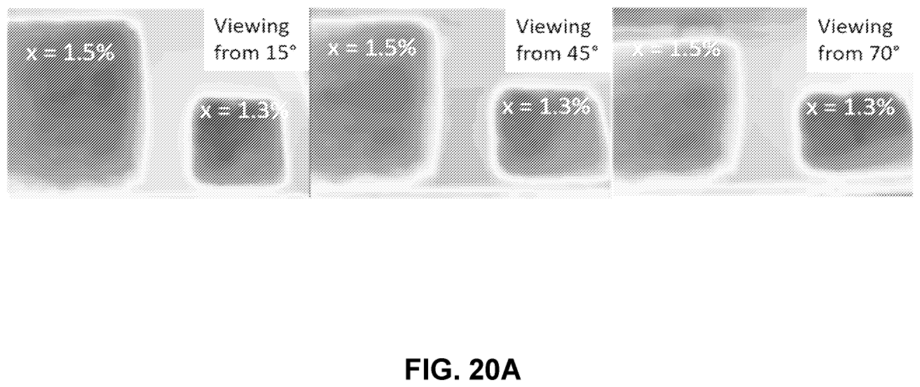

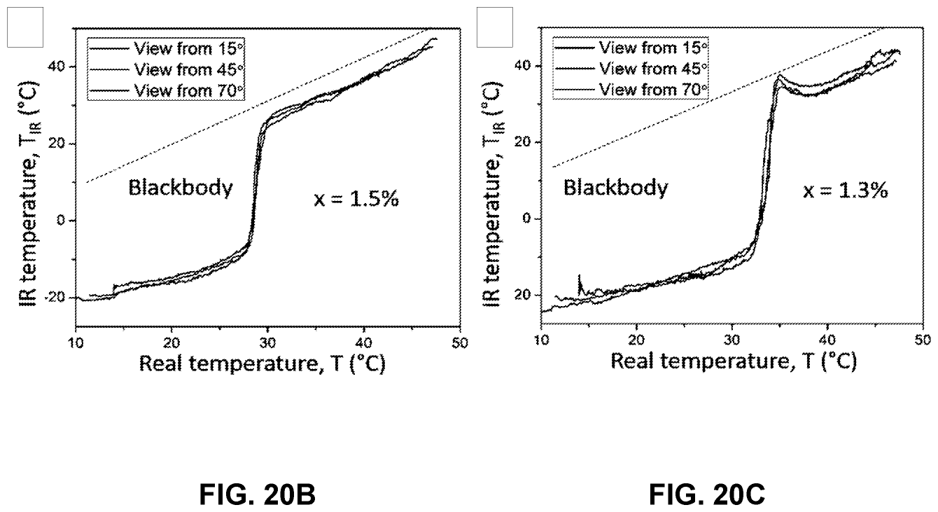

Furthermore, the TIS is able to be applied to most near-ambient applications over the desired window of temperatures near T_{MIT}. Because T_{MIT} can be pre-set by the W fraction x, the T_{MIT} of TIS, along with its working temperature range, can be precisely designed to fit various applications. In addition, the angular independence of the SPC (FIGS. 20A-20C) as well as the mechanical flexibility allow TIS to be applied to non-flat, arbitrary surfaces with little impact to the performance.

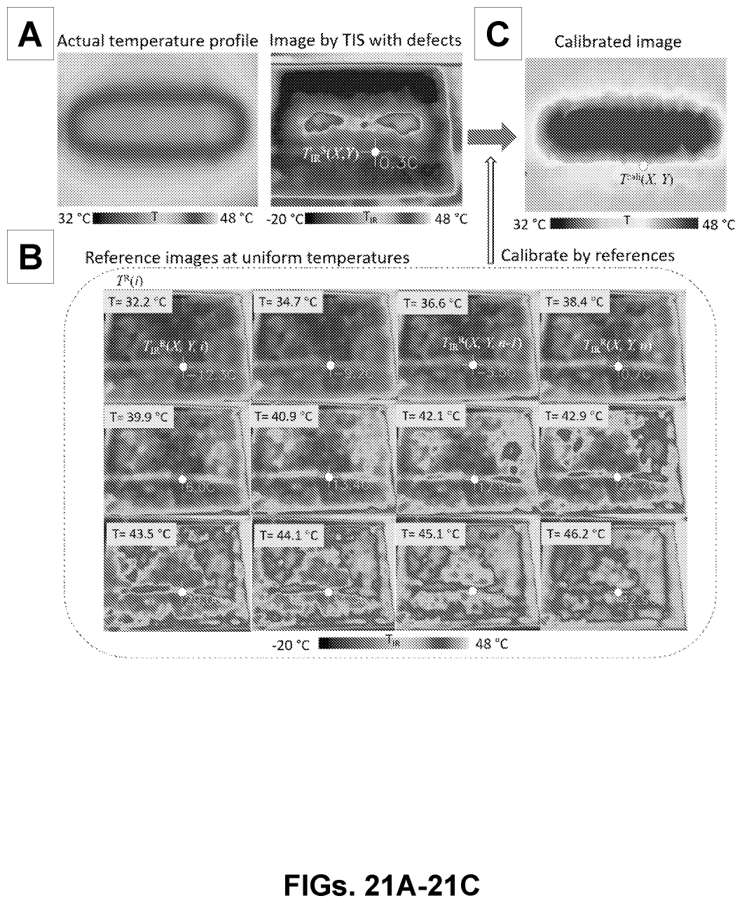

All the IR images in the main figures show the map of T_{IR}, which represent thermal features of the object but is numerically different from a map of Tin the case of imaging with TIS. A map of T can be readily converted from the above T_{IR} image using the SPC data: at each pixel of the image, by matching the T_{IR} with SPC in FIG. 4, the actual temperature T can be obtained. Note that this approach also works in the case when the TIS sensitization is spatially inhomogeneous, as long as the SPC of each pixel is measured and applied in the conversion to the image of T. Details of T map conversion in this case is described in FIGS. 21A-21C.

The twin heaters in FIG. 5A are made from two small tungsten wires separated by 1 mm. The heaters are attached on a 2 mm thick and 2 cm×2 cm large paper board substrate (white block in the figure). A few layers of 0.5 cm×1 cm large black carbon tapes are then stacked on the top of the heaters, with a total thickness of ˜1 mm (grey block in the figure). The emissivity of the top layer is 0.90-0.95.

The improvement of experimental sensitivity can be experimentally extracted from the converted T map by analyzing the size of artificial step features. For example, in the line profile crossing the centers of the two heaters in FIG. 5B, the two lobes of the heaters are indistinguishable, because the difference between the temperatures at the two peak points and the center dip is smaller than the experimental sensitivity of the camera (˜45 mK). In contrast, sensitizing with TIS results in a reduction of the system's sensitivity by 15 times down to ˜3 mK, thus making it possible to resolve the twin heaters. Therefore, the application of TIS, which much reduces the NEDT, also contributes to the improvement of spatial resolution (Dᵣ), especially in cases where the temperature gradient on the surface of object (∇T) is small, following a simplified equation as below:

Dᵣ=D_{r,c}+NEDT/|∇T|

in which D_{r,c} is the instrumentally limited spatial resolution of the camera.

### Demonstration of Electronic Imaging

As a fast, convenient, and non-destructive detection method, thermography is widely used in imaging thermal profiles of electronics, including tests for thermal-via structures, screening of voids at thermal interfaces, failure analysis in electronics packaging, reliability estimation of printed circuit boards (PCBs), and investigation of lateral electronic inhomogeneities.

In the weak electrical heating demonstration (FIG. 9), the chip was a TS3A44159 quad single pole double throw (SPDT) analog switch with two controls (Texas Instruments). The current was applied from the COM1 terminal to the NC1 terminal at on-state of this channel. For optimal demonstration, the background IR image without the applied current was subtracted from the one with current, which generates images of ΔT_{IR} caused by Joule heating.

The in-operando electronics analysis (oEA) (FIG. 10A) was performed on the processor unit of an Arduino Mega 2560 development board. In different modes characterized by IR imaging, the processor unit reads temperature data and exports terminal voltages at various frequency, which is 0 Hz for the stand-by mode, 250 Hz for the low-frequency mode, 500 Hz for the medium-frequency mode, and 1000 Hz for the high-frequency mode. For all conditions there was a background thermal feature, probably arising from the background operation (including power supply, clocking, etc.) of the processor unit. A correlation of the peak IR temperature at the processor surface and the reading/exporting frequency is shown in FIG. 10B.

The quantitative oEA (FIGS. 11A and 11B) was performed on a PCB with parallel circuit traces purchased from Uxcell. A finite-element analysis using the heat transfer module of COMSOL Multiphysics was developed to simulate the surface thermal profile at different current inputs. The surrounding air temperature (influenced by the cold plate) was calibrated based on the thermal profile of a single circuit trace with current from 0.4 A to 1.1 A. The model was then applied to map the currents in three traces with different experiment setups, which were then compared with the actual currents flowing in the circuit traces. Detailed information of the modelling can be found in FIGS. 22A-22B, FIGS. 23A-23B and FIGS. 24A-24B.

As an additional benefit, the coverage of TIS can eliminate the effect of emissivity variation across the object surface in thermal imaging, which is typical for PCBs.

### Experimental Details for In Vivo Tumor Growth

RMA cells were cultured in RPMI 1640 (ThermoFisher Scientific) and B16-F10 cells (obtained from UC Berkeley Cell Culture Facility) were cultured in DMEM (Thermofisher Scientific). In all cases media contained 5% FBS (Omega Scientific), 0.2 mg/ml glutamine (Sigma-Aldrich), 100 U/ml penicillin (Thermo Fisher Scientific), 100 μg/ml streptomycin (Thermo Fisher Scientific), 10 μg/ml gentamycin sulfate (Lonza), 50 μM β-mercaptoethanol (EMD Biosciences), and 20 mM HEPES (Thermo Fisher Scientific), and the cells were cultured in 5% CO₂.

For tumor growth experiments, RMA or B16-F10 cells were washed and resuspended in PBS (ThermoFisher Scientific) and injected subcutaneously into the belly of C57BL/6J mice (originally obtained from The Jackson Laboratory) at a dose of ˜10⁵ cells in a total volume of 50 μl per injection site. The tumor growth was monitored daily.

Note that as opposed to the hypervascularity around the natural cancer cells for human, the artificially introduced tumors in mice typically have impaired blood supplies, mainly due to the much faster growth rate of these tumors and the immunodeficiency of lab mice, causing a slightly lower local temperature, instead of higher as in the case of human.

Besides cancer screening, IR imaging of blood vessels is also critical for intravascular sampling of venous blood, intravenous injections of drug solutions, monitor of health parameters such as blood pressure, and diagnostics of circulatory disorders. This requirement can also be readily met with the milli-Kelvin sensitivity enabled by TIS, which shows a clear improvement in the imaging of cephalic veins (FIG. 8). We note that the scope of TIS application goes much beyond the limited cases demonstrated in this work, and can be extended to most areas of medical thermography, including checking of musculoskeletal disorders, diagnosis of rheumatic diseases, dermatological applications, evaluation of transplantation, and imaging of brain activities.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A structured product, comprising:
at least two layers comprising a first layer and a second layer;
wherein:
the first layer comprises at least one material having a temperature-dependent wavelength-integrated emissivity;
the second layer comprises at least one reflective material that is reflective to light in an 8-14 μm wavelength range; and
the structured product has a positive temperature-dependent wavelength-integrated emissivity.

2. The structured product of claim 1, wherein the at least one material comprises doped or undoped vanadium dioxide, or a combination thereof.

3. The structured product of claim 1, wherein the at least one material is doped with tungsten, chromium, gallium, aluminum, or any combination thereof.

4. The structured product of claim 1, wherein the at least one material comprises tungsten-doped vanadium dioxide having a formula of WₓV₁₋ₓO₂, wherein x is 0-5%, 0.1-2%, or 1-1.5%.

5. The structured product of claim 1, wherein, within a temperature range of −100 to 100° C., the at least one material has a wavelength-integrated emissivity temperature-dependence of at least 0.01 per ° C., at least 0.05 per ° C., at least 0.1 per ° C., or at least 0.2 per ° C., wherein the wavelength-integrated emissivity is integrated over a wavelength range of 8-14 μm.

6. The structured product of claim 1, wherein the wavelength-integrated emissivity is between 0.3 to 1, wherein the wavelength-integrated emissivity is integrated over a wavelength range of 8-14 km.

7. The structured product of claim 1, wherein the at least one material exhibits a thermally-triggered phase transition from an insulating phase to a metallic phase when temperature is increased, and optionally wherein the phase transition is reversible.

8. The structured product of claim 7, wherein, in a temperature range of 20-60° C., the thermally-triggered phase transition results in an increase in the wavelength-integrated emissivity of at least 0.2, wherein the wavelength-integrated emissivity is integrated over a wavelength range of 8-14 μm.

9. (canceled)

10. (canceled)

11. The structured product of claim 1, wherein the at least one reflective material comprises a metallic material, a ceramic, an artificial photonic structure, or a combination thereof.

12. (canceled)

13. (canceled)

14. (canceled)

15. The structured product of claim 1, further comprising at least one dielectric material.

16. The structured product of claim 15, wherein the at least one dielectric material has a transmittance of at least 25% to light in a wavelength range of 8-14 km.

17. The structured product of claim 15, wherein the first layer further comprises the at least one dielectric material.

18. The structured product of claim 15, wherein the at least one material is dispersed in or on the at least one dielectric material.

19. (canceled)

20. The structured product of claim 15, wherein the structured product further comprises a third layer disposed between the first and second layers, wherein the third layer comprises the at least one dielectric material.

21. The structured product of claim 18, wherein, when the at least one material is in a metallic phase, at least one of the following is satisfied:
(a) components of the dispersed material are spaced from each other such that a quarter wavelength photonic resonance cavity is formed with light having a wavelength of 8-14 μm;
(b) the dispersed material in or on the first layer is spaced from the at least one reflective material such that a quarter wavelength photonic resonance cavity is formed with light having a wavelength of 8-14 μm;
(c) the first layer comprises a continuous film of the at least one material, and the continuous film is spaced from the at least one reflective material such that a quarter wavelength photonic resonance cavity is formed with light having a wavelength of 8-14 μm; or
(d) any combination thereof.

22. (canceled)

23. (canceled)

24. (canceled)

25. (canceled)

26. (canceled)

27. The structured product of claim 20, wherein the structured product comprises a trilayer structure, wherein the first layer comprises WₓV₁₋ₓO₂, the second layer comprises the at least one reflective material, and the third layer comprises the at least one dielectric material, wherein x is 0-5% or 1-1.5%, and wherein the third layer is disposed between the first layer and the second layer.

28. The structured product of am claim 20, wherein the structured product comprises a trilayer structure, wherein the first layer comprises WₓV₁₋ₓO₂, the second layer comprises barium fluoride, and the third layer comprises aluminum, wherein x is 0-5% or 1-1.5%, and wherein the second layer is disposed between the first layer and the third layer.

29. (canceled)

30. (canceled)

31. (canceled)

32. (canceled)

33. (canceled)

34. The structured product of claim 20, wherein the third layer has a thickness that satisfies the following equation:
d=(0.25×m×λ)/n
wherein d is thickness of the third layer, m is any integer greater than or equal to one, n is the real part of the refractive index of the third layer, and λ is a resonance peak wavelength in a range of 8-14 μm.

35. The structured product of claim 1, further comprising a flexible substrate disposed on the first layer, the second layer, or both the first layer and the second layer.

36. The structure product of claim 35, wherein the flexible substrate is configured to conduct thermal energy to the at least one material.

37. The structured product of claim 35, further comprising an adhesive or glue disposed on a surface of the flexible substrate.

38. The structured product of claim 35, wherein the flexible substrate comprises a polymer tape, polyethylene tape, SCOTCH tape, KAPTON tape, woven fabric, nonwoven fabric, or any combination thereof.

39.-53. (canceled)
